(19) United States
(12) Patent Application Publication
(10) Pub. No.: US 2026/0352461 A1
(43) Pub. Date: Nov. 5, 2026

(54) SYSTEM AND METHOD FOR DELEGATED COMPUTING

(71) Applicant: Wisconsin Alumni Research Foundation, Madison, WI (US)

(72) Inventor: Rishab Goyal, Madison, WI (US)

(21) Appl. No.: 19/190,191

(22) Filed: Apr. 25, 2025

(51) Int. Cl. H04L 9/14

(52) U.S. Cl. CPC H04L 9/14

(57) ABSTRACT

A device may store private-data string and public-data string on a delegated computing device performing a computation. A device may generate a computational proof that defines proof-certificate using, as input to a computational proving algorithm: a common reference string, public input as an instance element in the computational proving algorithm and based on at least one of: the public-data string or a public-hash digest of the public-data string, and private input as a witness element in the computational proving algorithm and based on at least one of: the private-data string or a private-hash digest of the private-data string. A device may output, to a client device, a proof output including a proof-bit element and the proof-certificate.

### BACKGROUND

Delegated computing involves delegating computational tasks to a third party, such as a cloud service, while ensuring the correctness and integrity of the computations. This is particularly useful in scenarios where the delegator has limited computational resources or needs to offload intensive tasks. The computing device may utilize memory/data within the cloud, compute functions on this memory and return, to the delegating computer, a “proof” that the computations were performed correctly and with appropriate dataset. The mathematical proof concept is crucial in the context of cloud computing and data outsourcing, where trust and verification are paramount.

Delegation of computation has immense practical applications, in part due to rapid rise in popularity of blockchains and cloud services. While constructing non-interactive succinct proofs for delegation of computation is believed to be impossible information theoretically, this task is known to be feasible under computational hardness as long as soundness of the system is desired only against polynomial time adversaries.

Succinct non-interactive arguments (SNARGs) are powerful proof systems that solve the problem of publicly verifiable delegation. Over the last several years, numerous works have constructed SNARGs for various subclasses of NP. All these are useful for publicly verifiable delegation of different types of deterministic computation. SNARGs for general non-deterministic computations are desired to go beyond delegation of deterministic computation. Security may be defined by a variety of standard cryptographic assumptions, including Decisional Diffie-Hellman (DDH), Learning with Errors (LWE), or k-linear assumption.

### Non-Interactive Zero-Knowledge Arguments:

A non-interactive zero knowledge argument system (NIZK) for an NP language L is a standard two-party proof system defined in the CRS model, where a prover wants to convince a verifier that an instance x∈L, without the revealing any information about the corresponding witness ω. All parties have access to a public common reference string (crs). “Soundness” states that any polytime cheating prover should not be able to convince the verifier of a false assertion, while zero-knowledge requires that the proof string a should be simulatable given just a valid instance x. A stronger notion of knowledge soundness requires the system to additionally support efficient extraction of a valid witness o from any accepting proof a for an instance x. NIZKs are a fantastic and fundamental cryptographic tool with numerous applications across cryptography.

Almost all NIZK systems built from standard tools result in proofs and CRS of large size. That is, the proof certificate size |π|, and the size of |crs|=poly(λ, |x|, |ω|). In particular, the proof size is much larger than the witness size, lol. One notable exception is the work of Gentry et al. that designed rate-1 NIZKs. H ere “rate-1” refers to the fact that the proof certificate size “|π|” =|ω|+poly(λ). Gentry et al. “Using fully homomorphic hybrid encryption to minimize non-interative zero-knowledge proofs.” journal of Cryptology, 28(4):820-843, 2015. This work, however, crucially relies on fully-homomorphic encryption (FHE) to perform hybrid encryption to reduce the proof size. Thus, despite the fact that the community has developed multiple approaches for designing NIZKs from a variety of standard tools and assumptions over the last 30+ years, the only known construction we have for rate-1 NIZKs relies on the LWE assumption.

### Fully-Homomorphic NIZKs:

The concept of homomorphism in NIZKs, referred to herein as fully-homomorphic NIZK, was to enable homomorphic computations over independently generated NIZK proofs. To avoid trivial impossibilities, the standard approach to formalize homomorphism in NIZK systems was to consider an NP language, where each instance contains a pair of circuit and Boolean output (C, b) and a witness ω is an input string such that C(ω)=b. In addition to the standard prover/verifier algorithms, homomorphic NIZK systems have a special proof evaluation, Eval. It takes k tuples of the form {(Cᵢ, bᵢ, πᵢ)}_{i∈[k]} and a Boolean circuit C that takes k bits as input. The goal of the evaluation algorithm is to generate a NIZK proof for the statement (C′, b′), where b′=C(b₁, . . . , bₖ) and C′ is the circuit C composed with circuit Cᵢ on its i-th input wire. Such a composition maintains the invariant that (C′, b′) will be a valid instance if every (Cᵢ, bᵢ) is a valid instance. This is because C′(ω₂, . . . , ωₖ) is same as C(C₁(ω₁), . . . , Cₖ(ωₖ)), by definition.

Unlike FH E, there are no special compactness requirements from evaluated proofs. Despite that, there does not exist any canonical approach to design homomorphic NIZK. The reason is that the naive approach of simply setting the evaluated proof as π₁, . . . , πₖ along with circuit C has several issues. First, the evaluated proof does not necessarily satisfy zero-knowledge property, as the evaluated proof leaks intermediate wire values in the circuit computation. For example, if C is just a tree of or gates and b′=1, then (ideally) the evaluated proof should hide which of the input bits from b1 to bₖ are 1. However, the naive approach leaks that in the clear. Second, the evaluated proof does not resemble an ‘honestly generated proof’ for the instance (C′, b′). Thus, a verifier can clearly distinguish whether the NIZK proof is an evaluated proof or it is a fresh proof.

To address these issues and enable new applications, an unlinkability property for homomorphic NIZKs states that an evaluated proof must be indistinguishable from any honestly generated proof for the same instance. Combining the unlinkability property with the zero-knowledge property, we obtain that evaluated proofs are also indistinguishable from simulated proofs.

### SUMMARY

In some aspects, the techniques described herein relate to a method for delegated computing, including: storing private-data string xₚᵣ and public-data string x_{pb} on a delegated computing device performing a computation; generating a computational proof that defines proof-certificate a using, as input to a computational proving algorithm: a common reference string, public input as an instance element in the computational proving algorithm and based on at least one of: the public-data string x_{pb} or a public-hash digest h_{pb} of the public-data string x_{pb}, and private input as a witness element in the computational proving algorithm and based on at least one of: the private-data string xₚᵣ or a private-hash digest hₚᵣ of the private-data string xₚᵣ, and output, to a client device, a proof output including a proof-bit element b and the proof-certificate π.

In some aspects, the techniques described herein relate to a method, further including determining the common reference string using a setup algorithm using inputs of: a security parameter 1^{λ}, public-data length n_{pb} of the public-data string x_{pb}, private-data length nₚᵣ of the private-data string xₚᵣ, and a max configuration size S and a run time T associated with a delegated computing device performing a computation associated with the computational proof.

In some aspects, the techniques described herein relate to a method, further including: determining the private-hash digest hpr using, as input to a hash algorithm: the private-data string xpr, and a hash key; and determining an encrypted private-hash-digest ehpr using, as input to an encryption algorithm; a random value r, the private-hash digest hpr, and a public-key encryption (PKE) scheme public key.

In some aspects, the techniques described herein relate to a method, further including: generating an encryption computational proof defining encryption proof certificate πenc using as input to an encryption proving algorithm: an encryption sub-common reference string zk.crs_{enc} of the common reference string, an instance value based on the encrypted private-hash-digest ehₚᵣ, and witness value based on the private-data string xₚᵣ, the private-hash digest hₚᵣ, and the random value r.

In some aspects, the techniques described herein relate to a method, further including: determining a public-hash digest h_{pb} based on the public-data string x_{pb} and the hash key; determining a configuration-state digest hΣ based on a configuration state of the delegated computing device when performing the computation, and the hash key; generating a delegation computational proof that defines the proof-bit element b, and delegation proof certificate del.π using as input to a delegation proving algorithm: a delegation sub-common reference string zdel of the common reference string, and a configuration state element of the delegated computing device when performing the computation; wherein the computational proof defines the proof-certificate a using as input to the computational proving algorithm: a computation-proof sub-common reference string zk.crs_{edel}, instance element based on: the public-hash digest h_{pb}, the encrypted private-hash-digest ehₚᵣ, the configuration-state digest hΣ, and the proof-bit element b, and witness element based on: the private-hash digest hₚᵣ, the random value r, and the delegation proof certificate del.π; wherein the proof output further includes the encrypted private-hash-digest ehₚᵣ, and the encryption proof certificate πenc.

In some aspects, the techniques described herein relate to a method, at least one of the encryption computational proof, the delegation computational proof, and the computational proof being based on a non-interactive zero knowledge proof scheme.

In some aspects, the techniques described herein relate to a method, the proof output further including the encryption proof certificate πenc and an auxiliary value based on the private-data string xₚᵣ and the random value r.

In some aspects, the techniques described herein relate to a method, method further including: receiving another delegated-computation request, including the auxiliary value and another computation to be completed using the private-data string xₚᵣ; generating another computational proof that defines another proof-certificate πaux, using, as input to a computational proving algorithm: the common reference string, public input as an instance element and based on at least one of: the public-data string x_{pb} or a public-hash digest h_{pb} of the public-data string x_{pb}, witness element based on the auxiliary value; and output another proof output including the proof-bit b, the encryption proof certificate πenc, and the other proof-certificate πₐᵤₓ.

In some aspects, the techniques described herein relate to a method, further including: identifying previously identified: encrypted private-hash-digest ehₚᵣ, the random value r, and a delegation proof certificate del.π generated using the private-data string xₚᵣ, and associated with the auxiliary value; wherein: the common reference string used to generate the other computational proof is a computation-proof sub-common reference string z_{edel}, the instance element used to generate the other computational proof is based on: the public-hash digest h_{pb}, the encrypted private-hash-digest ehₚᵣ, a configuration-state digest hπ, and the proof-bit b, and the witness element used to generate the other computational proof is based on: the private-hash digest hₚᵣ, the random value r, and the delegation proof certificate del.π.

In some aspects, the techniques described herein relate to a method, further including generating the private input by encoding the private-data string xₚᵣ to yield secret information and an encoding value (ρ).

In some aspects, the techniques described herein relate to a method, wherein the public input is based on the public-data string x_{pb} and the encoding value (ρ).

In some aspects, the techniques described herein relate to a system for delegated computing, including: a delegated computing device having: a data storage repository storing private-data string xₚᵣ and public-data string x_{pb}; and a proving module including a proving processor and computer-readable proving instructions that when executed by the proving processor cause the proving module to: receive delegated-computation request, from the compute machine, including a computation to be completed using the private-data string xₚᵣ, generate a computational proof, defining proof-bit b and proof-certificate a, using, as input to a computational proving algorithm: a common reference string, instance value based on public input based on at least one of: the public-data string x_{pb} or a public digest h_{pb} of the public-data string x_{pb}, and witness value based on private input based on at least one of: the private-data string xₚᵣ or a private digest hₚᵣ of the private-data string xₚᵣ, and output, to a client device, a proof output including the proof-bit b and the proof-certificate a; and the client device including a verifying module having a verifying processor and verifying computer-readable verifying instructions that when executed by the verifying processor cause the verifying device to: receive the proof output, and generate a verification result based on the common reference string, a public-hash digest h_{pb} of the public-data string xpb, the proof-bit b, and the proof-certificate π.

In some aspects, the techniques described herein relate to a system, the proving device or the verifying device further being caused to calculate the common reference string using a setup algorithm using inputs of: a security parameter 1^{λ}, an public-data length n_{pb} of the public data x_{pb}, a private-data length nₚᵣ of the private data xₚᵣ, and a max configuration size S for the delegated computing device, and a run time T.

In some aspects, the techniques described herein relate to a system, the proving device and the verifying device implementing a non-interactive zero-knowledge scheme.

In some aspects, the techniques described herein relate to a system, the computational proof further using as input a configuration state of the delegated computing device when performing the computation.

In some aspects, the techniques described herein relate to a system, the proving instructions further causing, to generate the private input, the proving device to: determine the private-hash digest hₚᵣ using, as input to a hash algorithm: the private data xₚᵣ, and a hash key known to both the proving device and the verifying device; and determine an encrypted private-hash-digest ehₚᵣ using, as input to an encryption algorithm; a random value r, the private-hash digest hₚᵣ, and a public-key encryption (PKE) scheme public key.

In some aspects, the techniques described herein relate to a system, the proving instructions further causing the proving device to: generate an encryption computational proof defining encryption proof certificate πenc using as input to an encryption proving algorithm: an encryption sub-common reference string zk.crs_{enc} of the common reference string, the encrypted private-hash-digest ehₚᵣ as an instance value, and a witness value based on the private data xₚᵣ, the private-hash digest hₚᵣ, and the random value r.

In some aspects, the techniques described herein relate to a system, the proving instructions further causing the proving device to: determine a public-hash digest h_{pb} based on the public data x_{pb} and the hash key; determine a configuration-state digest hΣ based on a configuration state of the delegated computing device when performing the computation, and the hash key; generate a delegation computational proof defining the bit-value b, and delegation proof certificate del.π using as input to a delegation proving algorithm: a delegation sub-common reference string z_{del} of the common reference string, and a configuration state element of the delegated computing device when performing the computation; wherein the computational proof defines the proof-certificate a using as input to the computational proving algorithm: a computation-proof sub-common reference string z_{edel}, instance element based on: the public-hash digest h_{pb}, the encrypted private-hash-digest ehₚᵣ, the configuration-state digest hΣ, and the bit-value b, and witness element based on: the private-hash digest hₚᵣ, the random value r, and the delegation proof certificate del.π; wherein the proof output further includes the encrypted private-hash-digest ehpr, and the encryption proof certificate πenc.

In some aspects, the techniques described herein relate to a system, the generate the verification result including: generate an encryption verification using: the encryption sub-common reference string zk.crs_{enc}, the encrypted private-hash-digest ehₚᵣ, and encryption proof certificate πenc; and generate a computation-proof verification using: computation-proof sub-common reference string z_{edel}, the public-hash digest h_{pb}, and the proof-certificate a.

In some aspects, the techniques described herein relate to a system, the proof output further including the encryption proof certificate πenc and an auxiliary value based on private-data string xₚᵣ and the random value r.

In some aspects, the techniques described herein relate to a system, the proving instructions further causing the proving processor to: receive another delegated-computation request, including another computation to be completed using the private-data string xₚᵣ and the auxiliary value; generate another computational proof, defining another proof-certificate πaux, using, as input to a computational proving algorithm: the common reference string, instance element based on public input based on at least one of: the public-data string x_{pb} or a public digest h_{pb} of the public-data string x_{pb}, witness element based on the auxiliary value; and output another proof output including the proof-bit b, the encryption proof certificate πenc, and the another proof-certificate πaux.

In some aspects, the techniques described herein relate to a system, the proving instructions further causing the proving processor to, using the auxiliary value, identify previously identified: encrypted private-hash-digest ehₚᵣ, the random valuer, and a delegation proof certificate del.π generated using the private data xₚᵣ, wherein: the common reference string used to generate the another computational proof is a computation-proof sub-common reference string z_{edel}, the instant element used to generate the another computational proof is based on: the public-hash digest h_{pb}, the encrypted private-hash-digest ehₚᵣ, a configuration-state digest hΣ, and the proof-bit b, and a witness element based on: the private-hash digest hₚᵣ, the random value r, and the delegation proof certificate del.π.

In some aspects, the techniques described herein relate to a system, further including one or both of: the private input being generated by encoding the private-data string xpr to yield secret information and an encoding value (ρ); and the public input is based on the public-data string x_{pb} and the encoding value (ρ).

### BRIEF DESCRIPTION OF THE FIGURES

FIG. 1 shows one system for delegated computing, in an embodiment.

FIG. 2 shows an example block diagram of CRS, useable in an encrypted RAM delegation scheme by system, in an embodiment.

FIG. 3 shows proof generation engine in further detail used to implement encrypted RAM delegation.

FIG. 4 shows corresponding verifier engine in further detail used to implement encrypted RAM delegation.

FIG. 5 shows an example method for encrypted RAM delegation, in an embodiment implemented by the system, and particularly using the components shown in FIGS. 2-4.

FIG. 6 shows system including a reusable proof, in embodiments.

FIG. 7 shows an example method for encrypted RAM delegation with reusable proof, in an embodiment implemented by the system, and particularly using the components shown in FIG. 6.

FIG. 8 shows proof generation engine in further detail used to implement encrypted RAM delegation with rate-1 characteristic.

FIG. 9 shows verifier engine including data to implement rate-1 encrypted RAM delegation.

FIG. 10 shows an example method for rate-1 encrypted RAM delegation, in an embodiment implemented by the system, and particularly using the components shown in FIGS. 2 and 8.

FIG. 11 shows proof generation engine in further detail used to implement encrypted RAM delegation with rate-1 characteristic.

FIG. 12 shows verifier engine including data to implement rate-1 encrypted RAM delegation.

FIG. 13 shows an example method for rate-1 encrypted RAM delegation, in an embodiment implemented by the system, and particularly using the components shown in FIGS. 11-12.

FIG. 14 shows a system for encrypted RAM delegation that implements Rate Preserving Maliciously Secure multiparty non-interactive secure computation (mrNISC) scheme, in an embodiment.

FIG. 15 shows the proof generation engine of each delegated computing machine in further detail.

FIG. 16 shows the verifier engine of the client device in further detail.

FIG. 17 shows a method that implements Rate Preserving Maliciously Secure multiparty non-interactive secure computation (mrNISC) scheme using system, in an embodiment.

FIG. 18 shows proof generation engine and associated functionality to implement an unbounded homomorphic NIZK scheme for RAM delegation, in an embodiment.

FIG. 19 depicts a method for homomorphic NIZK implementation, in an embodiment.

### DETAILED DESCRIPTION

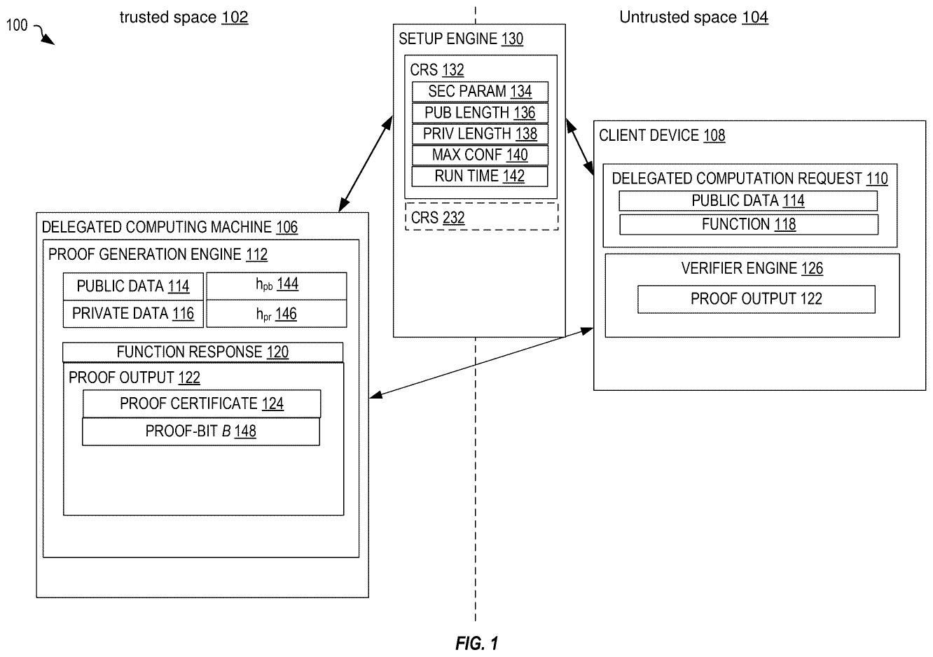

FIG. 1 shows one system 100 for delegated computing, in an embodiment. One system 100 is shown representing a trusted space 102 and untrusted space 104 separated by a dashed line. The trusted space 102 represents computing environment where data is capable of being stored privately and securely. Untrusted space untrusted space 104 represents computing environment where data is publicly available (e.g., a block-chain, publicly available storage/ledger, or other computing environment).

One system 100 includes a delegated computing device 106 and a client device 108. Client device 108 may be a computing device that desires to have delegated computing device 106 perform a computation on a set of data. In embodiments, client device 108 may be a device with less computing functionality than delegated computing device 106. For example, delegated computing device 106 may be a cloud computing device that is capable of scaling (ramp up) to desired computing power according to the given computing function and dataset size. To initiate delegated computing, delegated computing device 106 transmits a delegated computation request 110 to client device 108.

Delegated computing device 106 implements a RAM program. A RAM program is typically defined as a deterministic machine M represented using a fixed polynomial-sized set of states that has random access to a large memory (where the memory includes an explicit input and rest of it is initialized as zeros). Herein, the following representation for RAM machines as it enables a simpler exposition of the embodiments herein. Any RAM machine M that receives n bits of explicit input x={0,1}ⁿ, is associated with a work tape of size S=S(n) and a fixed set of states Q that the machine can be in at any point during machine execution. Formally, a machine M is associated with following components:

A set of machine states Q.

A memory M of size n+S. Without loss of generality, we assume that the explicit input x∈{0,1}ⁿ is written in the first n cells of the memory (i.e., x=(M₁, . . . , Mₙ)), and the rest of the memory (i.e., (Mₙ₊₁, . . . , M_{n+S})) corresponds to the work-tape of the machine. For ease of exposition, Wᵢ (for i∈[S]) denotes the work-tape. The work tape may be initialized as all zeros.

A state transition function δ with the following syntax:

$$δ : Q \times \{ 0 , 1 \} \to Q \times {\{ 0 , 1 \}}^{log ( n + S )} \times {\{ 0 , 1 \}}^{logS} \times \{ 0 , 1 \}$$

Here the transition function defines the execution of machine M at each time step.

There is a circuit C_{M} that computes the next step as follows:

C_{M}(q,rbit)=(q′,ridx′,widx,wbit)

The variable cfᵢ for the configuration of the machine when run for i steps, and let cf₀ be the initial configuration of the machine. M (z;1^{t}) denotes the running the machine M starting from cf₀ on input z for t steps that outputs cfₜ. The language of machine M is defined as follows:

[symbol]

={( [symbol] ,out):cf₀=initial configuration∧F(cf_{T})=out∧ [symbol] ( [symbol] ;1^{T})=cf_{T}} Equation (1)
where F(⋅) is a deterministic function that computes the output of the machine from the final configuration.

Embodiments herein may, although not always, apply to RAM machines that output a single bit 0/1. In this case, the language would be as follows:

[symbol]

={( [symbol] ,b):cf₀=initial configuration ∧ [symbol] (cf_{T})=b∧ [symbol] ( [symbol] ;1^{T})=cf_{T}} Equation (2)

Delegated computing device 106 includes a proof generation engine 112 which is configured to carry out a function or set of functions, as detailed below. The term “engine” as used herein means a tangible device, component, or arrangement of components implemented using hardware, such as by an application specific integrated circuit (ASIC) or field-programmable gate array (FPGA), Complex Programmable Logic Device(CPLD), for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, translated, or otherwise converted to an executable form prior to, or during, runtime. In an example, the software, when executed by the underlying hardware of the engine, causes the hardware to perform the specified operations. Accordingly, an engine is specifically configured (e.g., hardwired), or temporarily configured (e.g., programmed) to operate in a specified manner or to perform part or all of any operations described herein in connection with that engine.

In examples in which engines are temporarily configured, each of the engines may be instantiated at different moments in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out.

In addition, an engine may itself be composed of more than one sub-engines, each of which may be regarded as an engine in its own right. M oreover, in the embodiments described herein, each of the various engines corresponds to a defined functionality; however, it should be understood that in other contemplated embodiments, each functionality may be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Delegated computing device 106 stores public-data string x_{pb} 114 and private-data string xₚᵣ 116. Public-data string x_{pb} 114 is a publicly-available data string, and private-data string xₚᵣ 116 is a non-publicly available string that requires authorization for access. Delegated computing device 106 has access to private-data string xₚᵣ 116, and public-data string x_{pb} 114, but client device 108 does not have access to private-data string xₚr 116. Therefore, client device 108 needs ability to trust that delegated computing device 106 is operating on correct data when responding to the delegated computation request 110 that requires delegated computing device 106 to analyze/compute using private-data string xₚᵣ 116.

In response to delegated computation request 110 defining a function (computation to be performed), proof generation engine 112 operates to generate a function response 120, which is the computational answer to the delegated computation request 110, and provide a proof output 122.

Proof output 122 is generated, in an embodiment, using a NIZK proof scheme. The prover algorithm implemented by proof generation engine 112 (e.g. “PROVE”), takes two input strings, public-data string x_{pb} 114 and private-data string xₚᵣ 116 (or portions thereof). Proof generation engine 112 generates a short proof certificate 124 (π) that is used by a corresponding verifier engine 126 at client device 108.

Corresponding verifier engine 126 operates to check validity of computation of [symbol] (function response 120 and proof output 122), while given only the public-data string x_{pb} 114 as an additional input. In words, consider y= [symbol] (x_{pb}, xₚᵣ), corresponding verifier engine 126 and the functionality described herein allows proving validity of this computation even if corresponding verifier engine 126 doesn't know to private-data string xₚᵣ 116.

Intuitively, for soundness, one system 100 requires that if a proof certificate 124 gets verified for some private-data string xₚᵣ 116 input and output y, then there must exist a private-data string xₚᵣ 116 input such that y= [symbol] (x_{pb}, xₚᵣ). Even further, we consider extraction soundness, where such a private-data string xₚᵣ 116 should be efficiently extractable from an accepting proof certificate π. To formally capture an appropriate notion of privacy for private-data string xₚᵣ 116, system 100 may utilize a zero-knowledge style guarantee for delegated proofs, called input hiding. Intuitively, it states that an honestly computed proof π for y= [symbol] (x_{pb}, xₚᵣ) should be efficiently simulatable, given only public-data string x_{pb} 114 and proof output 122.

### Setup Function to Generate Crs (Setup)

A setup process may be implemented by a setup engine 130, to coordinate between delegated computing device 106 and client device 108 to generate a common reference string 132. Common reference string 132 may be based on an input of a security parameter λ 134 (e.g., 1^{λ}), a public input length n_{pb} 136, a private input length nₚᵣ 138 (e.g., 1^{npr}), a max configuration size S 140 for the delegated computing device 106, and the running time T 142 of the delegated computing device 106. Of note, the notation “The notation “1^{λ}” means a string with X characters all of them equal to 1. For instance, if λ=3, then 1^{λ} is 111 (the same for “1^{npr}” or similar notation herein). It should be appreciated that other format of the CRS 132 may be utilized without departing from scope hereof, such as not using the 1^{λ} format for 134// or the 1^{npr} format for nₚᵣ 138.

Common reference string 132 is transmitted to each of delegated computing device 106 and client device 108 for use by proof generation engine 112 and corresponding verifier engine 126, respectively.

Setup engine 130 may be operated by one of delegated computing device 106 and client device 108, or may be operated by a trusted third-party device.

### Proof Generation Using Proving Algorithm (Prove)

Proof output 122 may be generated, in embodiments, as follows. In response to delegated computation request 110, proof generation engine 112 generates a computational proof that defines proof-certificate π 124 and a proof-bit b 148 using, as input to a computational proving algorithm:
(1) the common reference string 132,
(2) public input as an instance element in the computational proving algorithm and based on at least one of: the public-data string x_{pb} 114 or a public-hash digest h_{pb} 144 of the public-data string x_{pb} 114 and
(3) private input as a witness element in the computational proving algorithm and based on at least one of: the private-data string xₚᵣ 116 or a private-hash digest hₚᵣ 146 of the private-data string xₚᵣ 116.

The proof generation engine 112 (or corresponding verifier engine 126) may determine the public-hash digest h_{pb} 144 using, as input to a hash algorithm: the public-data string x_{pb} 114 and a hash key (ht.hk). The proof generation engine 112 may determine the private-hash digest hₚᵣ 146 using, as input to a hash algorithm: the private-data string xₚᵣ 116 and a hash key (ht.hk).

### Verifying Algorithm (Verify)

In response to receiving proof output 122 at client device 108 from delegated computing device 106, corresponding verifier engine 126 may implement a computational verifying algorithm to confirm that delegated computing device 106 using correct private-data string xₚᵣ 116. As input to the computational verifying algorithm, the common reference string 132, public-hash digest h_{pb} 144 of the public-data string x_{pb} 114, the proof-bit b 148, and the proof-certificate π 124.

The above discussion provides an example of RAM delegation using a private/public data separation, where the proof grows poly with respect to the size of the private-data string xₚᵣ 116, and possibly a seed value (e.g., a random or arbitrary value added to xₚᵣ when creating the witness value for the proving algorithm).

In embodiments, the computational proving algorithm and computational verifying algorithm satisfies a NIZK-based computational proving/verifying algorithm scheme. This NIZK-based computational proving/verifying algorithm scheme serves as foundation for a variety of additional features that may be implemented using system 100, as discussed below.

By satisfying the NIZK-based computational proving algorithm, the proof output 122 of the present embodiments allow for the following properties: completeness, efficiency, input hiding, soundness, and straight-line extraction. The following establishes these properties of the proof output 122, assuming delegated computing machine 106 is represented by [symbol] , and accepts an input x within T steps such that both the proof size and the verifier's running time only grow with polylog(T, |x|). [symbol] describes the language of the machine M consisting of all (x_{pb}, xₚᵣ)

Completeness: For every λ, T, S, n_{pb}, nₚᵣ∈ [symbol] s.t. T, S, n_{pb}≤2λ, nₚᵣ=poly(λ), x_{pb}∈{0, 1}n_{pb}, xₚᵣ∈{0, 1}nₚᵣ, (x_{pb}, xₚᵣ)∈LM,T it holds that:

$$Pr [ Verify ( crs , hpb , b , π ) = 1 : \frac{crs ← Setup ( {1}^{λ} , {n}_{pb} , {1}^{{n}_{pr}} , S , T )}{( b , π ) ← Prove ( crs , {x}_{pb} , {x}_{pr} )} ] = 1$$

Efficiency: The crs and proof size, and the setup and the verifier running time are poly(λ, log T, log n_{pb}, nₚᵣ), and the prover's running time is poly(λ, T, n_{pb}, nₚᵣ).

Input Hiding: There exists a stateful PPT simulator S such that for any PPT adversary A, there is a negligible function negl(⋅) such that for all λ, n_{pb}, nₚᵣ S, T∈N:

$$\vert \begin{matrix}Pr [ 1 ← {A}^{Prove ( crs , \cdot , \cdot )} ( crs ) : crs ← Setup ( {1}^{λ} , {n}_{pb} , {1}^{{n}_{pr}} , S , T ) - \\ Pr [ 1 ← {A}^{{𝒪}^{S} ( \cdot , \cdot )} ( crs ) : crs ← Setup ( {1}^{λ} , {n}_{pb} , {1}^{{n}_{pr}} , S , T )\end{matrix} \vert \leq negl ( λ )$$

Soundness: For any stateful PPT adversary A, there is a negligible function negl(⋅) such that for all λ∈ [symbol] :

$$Pr [ \begin{matrix} & & ( {n}_{pb} , {1}^{{n}_{pr}} , S , T ) ← A ( {1}^{λ} ) , \\ \begin{matrix}Verify ( crs , {h}_{pb} , b , π ) = 1 \\ ∧ {Ax}_{pr} : ( {x}_{pb} , {x}_{pr} ) ∉ {ℒ}_{ℳ , T}\end{matrix} & \begin{matrix}:\end{matrix} & \begin{matrix}crs ← Setup ( {1}^{λ} , {n}_{pb} , {1}^{{n}_{pr}} , S , T ) , \\ ( {x}_{pb} , b , π ) ← A ( crs ) ,\end{matrix} \\ & & {h}_{pb} = HT . Hash ( ht . hk , {x}_{pb} )\end{matrix} ] \leq negl ( λ )$$

Straight-line Extraction. There exists a stateful PPT extractor ε such that for any stateful PPT adversary A, there is a negligible function negl(⋅) such that for all λ∈ [symbol] :

$$Pr [ \begin{matrix} & & ( {n}_{pb} , {1}^{{n}_{pr}} , S , T ) ← A ( {1}^{λ} ) , \\ \begin{matrix}Verify ( crs , {h}_{pb} , b , π ) = 1 \\ ∧ ( {x}_{pb} , {x}_{pr} ) ∉ {ℒ}_{ℳ , T}\end{matrix} & \begin{matrix}:\end{matrix} & \begin{matrix}( crs , td ) ← ε ( {1}^{λ} , {n}_{pb} , {1}^{{n}_{pr}} , S , T ) , \\ ( {x}_{pb} , b , π ) ← A ( crs ) ,\end{matrix} \\ & & {h}_{pb} = HT . Hash ( ht . hk , {x}_{pb} ) , \\ & & {x}_{pr}^{*} ← ε ( td , π )\end{matrix} ] \leq negl ( λ )$$

such that crs₁←ε(1^{λ}, nₚₚ, 1ⁿ^{ₚᵣ}, S, T) and crs₂←Setup(1^{λ}, n_{pb}, 1ⁿ^{ₚᵣ}, S, T) are indistinguishable.

### Encrypted Ram Delegation

The above-discussed Setup, Prove, Verify may be expanded to enable encrypted RAM delegation functionality in system 100. In the above foundational RAM delegation a prover (e.g., proof generation engine 112) generates a proof a to convince a verifier that a RAM machine [symbol] accepts an input x within T steps such that both the proof size and the verifier's running time only grow with polylog(T, |x|). In encrypted RAM delegation the input is partially private, namely, x=(x_{pb}, xₚᵣ) for some private (resp. public) input xₚᵣ (resp. x_{pb}). More specifically, consider RAM machine [symbol] , and an input (x_{pb}, xₚᵣ) where x_{pb} is a publicly known input, and xₚᵣ is a private input. Then an encrypted RAM delegation comprises of a setup algorithm that generates a CRS (which is given to all the algorithms), a prover that given (x_{pb}, xₚᵣ), generates a proof π, and a verifier that, given only a short digest h_{pb} (of public input x_{pb}), verifies a.

In the following discussion of Encrypted RAM Delegation, system 100 assumes [symbol] describes the language of the machine [symbol] consisting of all (x_{pb}, xₚᵣ) that are accepted by [symbol] within T steps. The Encrypted RAM Delegation scheme satisfies the following properties—(1) soundness: no PPT adversary can find an accepting (x_{pb}, π) s.t. for all xₚᵣ, (x_{pb}, xₚᵣ)/∈ [symbol] , (2) straight-line extraction: there is an extractor E such that for any accepting (x_{pb}, π), it holds that

$${x}_{pr}^{*} ← ε ( td , π )$$

(for some trapdoor td associated with the crs) and

$$( {X}_{pb} , {x}_{pr}^{*} ) ∈ {ℒ}_{ℳ , T} ,$$

(3) input hiding: there is a simulator that without knowing xₚᵣ generates proofs that are indistinguishable from the output of the prover, and (4) efficiency: the proof size and verification time grow with poly(log T, log|x_{pb}|, |xₚᵣ|). Note that if the proof doesn't grow with poly(|xpr|) then it will imply SNARGs for NP breaking the barrier as described in “Separating succinct non-interactive arguments from all falsifiable assumptions” by Gentry et al in Proceedings of the forty-third annual ACM symposium on Theory of computing, pages 99-108, 2011.

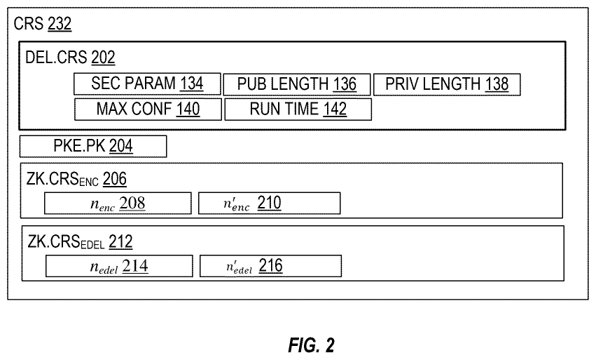

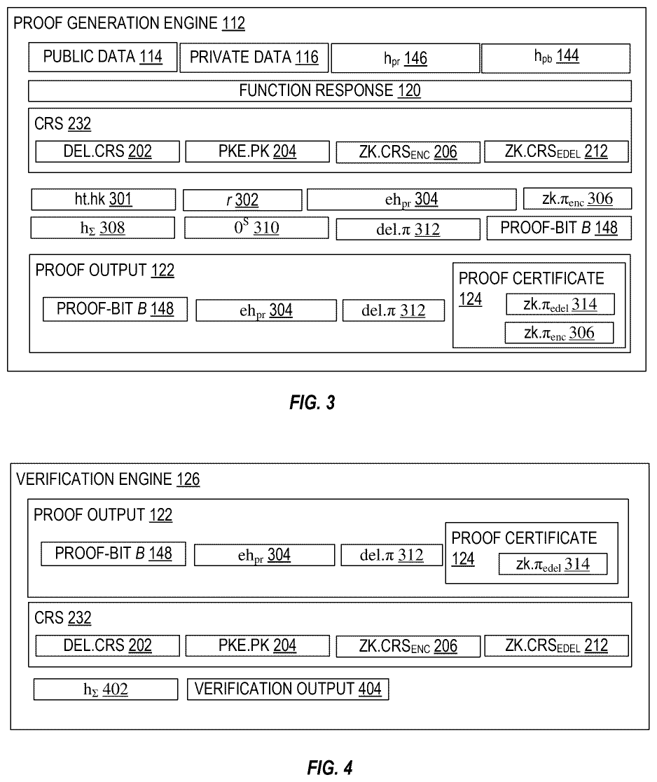

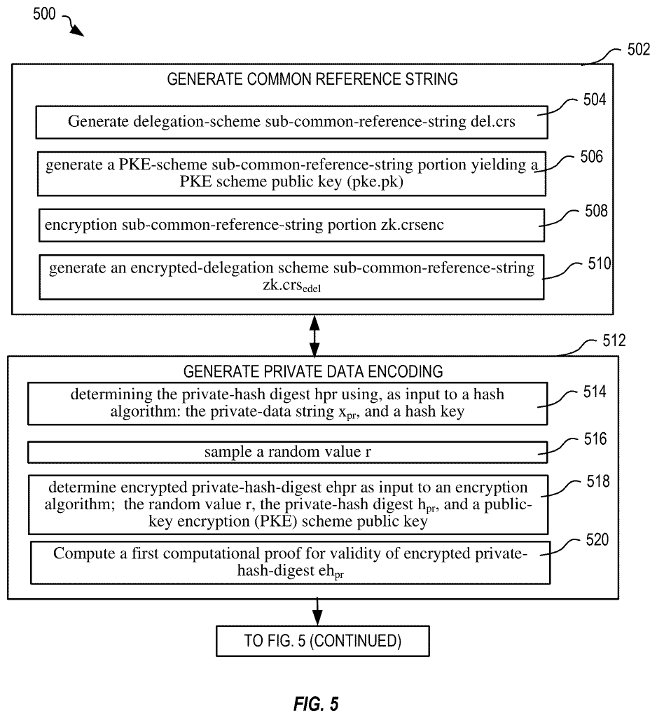

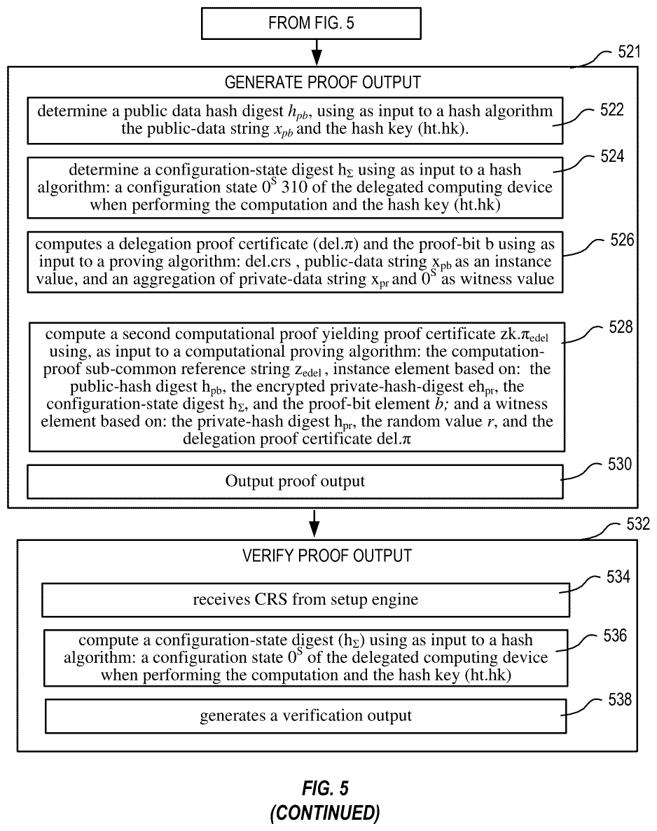

FIG. 2 shows an example block diagram of CRS 232, useable in an encrypted RAM delegation scheme by system 100, in an embodiment. FIG. 3 shows proof generation engine 112 in further detail used to implement encrypted RAM delegation. FIG. 4 shows corresponding verifier engine 126 in further detail used to implement encrypted RAM delegation. FIG. 5 shows an example method 500 for encrypted RAM delegation, in an embodiment implemented by the system 100, and particularly using the components shown in FIGS. 2-4. FIGS. 1-5 are best viewed together with the following description.

### Encrypted RAM Delegation—SETUP

CRS 232 is an example of common reference string 132, and includes additional information therein. CRS 232 is created, for example by setup engine 130 of system 100. CRS 232 is created by setup engine 130 implementing step 502 of method 500, for example. To generate CRS 232, setup engine 130 implements a setup algorithm using as input the security parameter X 134, the length of the public data string n_{pb} 136, and the max configuration size S 140 and the running time T 142 of the delegated computing device 106 similar to generation of common reference string 132, yielding delegation-scheme sub-common-reference-string del.crs 202 (step 504 of method 500). Del.crs 202 is therefore similar to common reference string 132.

Furthermore, the setup algorithm generates a PKE-scheme sub-common-reference-string portion using the security parameter X 134 as input to a PKE.Gen function, yielding a PKE scheme public key 204 (pke.pk) and associated secret key (pke.sk; not shown) (step 506 of method 500).

Furthermore, the setup algorithm generates a NIZK scheme for encryption sub-common-reference-string portion zk.crs_{enc} 206 using as input: n_{enc} 208 defined as the length of an encrypted private-hash-digest ehₚᵣ;

$${n}_{enc}^{′}$$

210 defined as the length of the private data plus the length of the private-hash-digest hₚᵣ plus a random value r. The setup algorithm may also yield a NIZK scheme for encryption trapdoor zk.td_{enc} (not shown) (step 508 of method 500).

Furthermore, the setup engine 130 generates an encrypted-delegation scheme sub-common-reference-string zk.crs_{edel} 212 using as input n_{edel} 214 defined as the length of a public-has digest h_{pb} plus the length of an encrypted private-hash-digest ehₚᵣ plus the length of configuration-state digest h_{Σ} based on a configuration state of the delegated computing device when performing the computation;

$${n}_{edel}^{′}$$

216 defined as the length of the private-hash-digest hₚᵣ plus a random value r plus the length of a delegation proof certificate del.π.

CRS 232 is then output from setup engine 130 to delegated computing device 106 and client device 108 as an aggregate of del.crs 202, PKE scheme public key 204, zk.crs_{enc} 206 and zk.crs_{edel} 212, and max configuration size S 140 (e.g., crs=(del.crs, pke.pk, zk.crs_{enc}, zk.crs_{edel}, S) (step 510 of method 500).

Accordingly, it should be appreciated that CRS 232 may be created and distributed intermittently while proof generation engine 112 is creating aspects of a given proof output 122 (for example the length of a delegation proof certificate del.π may not be known until aspects of proof generation engine 112 are executed). In other words, one or more of sub-steps 504, 506, 508 may be performed before or after other sub-steps of block 512 in method 500. Therefore, needed input used by setup engine 130 may be received from one or both of delegated computing device 106 and client device 108 to create CRS 232, and the final CRS 232 is transmitted to delegated computing device 106 and client device 108 for use by proof generation engine 112 and corresponding verifier engine 126, respectively.

### Encrypted RAM Delegation—ENCODE/PROVE

To implement the prove algorithm, with enhanced encrypted RAM delegation, the proof generation engine 112 implements the following, which is an example description of steps 512 and 521 of method 500 and associated sub-steps 514, 516, 518, 520, 522, 524, 526, 528, and 530.

Proof generation engine 112 receives CRS 232, or at least a sub-portion thereof, and parses into sub-components of the common reference string. For example, proof generation engine 112 may initially receive the del.crs 202 and PKE scheme public key 204 sub-components of CRS 232.

Step 512 of method 500 implements a private data encoding algorithm to encode and validate the private data used in responding to delegated computation request 110. Step 512 includes sub-steps 514, 516, 518, and 520.

At step 514 of method 500, proof generation engine 112 computes a hash digest, e.g., private-hash digest hₚᵣ 146, using as input to a hash algorithm the private-data string xₚᵣ 116 and a hash key 301 (ht.hk), which may be transmitted to proof generation engine 112 from setup engine 130, another device, or predetermined between delegated computing device 106 and client device 108. At step 516 of method 500, proof generation engine 112 may further sample a random value r 302. At step 518 of method 500, using random value 302, and the PKE scheme public key 204 as input to an encryption algorithm, proof generation engine 112 may generate encrypted private-hash-digest ehₚᵣ 304.

At step 520, Proof generation engine 112 may compute a first NIZK proof certificate zk.π_{enc} for validity of the encrypted private-hash-digest ehₚᵣ 304 using, as input to a NIZK proving algorithm: ZK.crs_{enc} 206 parsed from CRS 232; encrypted private-hash-digest ehₚᵣ 304 as the instance value in the NIZK proving algorithm; and, as the witness value to the NIZK proving algorithm, an aggregation of: the private-data string xₚᵣ 116, private-hash digest hₚᵣ 146, and the random value r 302. This yields first delegation proof certificate zk.π_{enc} 306.

Once the private data encoding step 512 is completed, method 500 continues by generating proof output 122 implementing 521 including sub-steps 522, 524, 526, 528, and 530.

Private-hash digest hₚᵣ 146, random valuer 302, and encrypted private-hash-digest ehₚᵣ 304, or the lengths thereof, may then be transmitted to setup engine 130 for generation of encryption sub-common-reference-string portion zk.crs_{enc} 206 using as input: n_{enc} 208 defined as the length of an encrypted private-hash-digest ehₚᵣ;

$${n}_{enc}^{′}$$

210 defined as the length of the private data plus the length of the private-hash-digest hₚᵣ plus a random value r. Setup engine 130 then returns encryption sub-common-reference-string portion zk.crs_{enc} 206 to proof generation engine 112 for further processing and generation of proof output.

At step 522 of method 500, proof generation engine 112 may compute a public data hash digest, e.g., public-hash digest h_{pb} 144, using as input to a hash algorithm the public-data string x_{pb} 114 and the hash key 301 (ht.hk). At step 524 of method 500, proof generation engine 112 may compute a configuration-state digest h_{Σ} 308 using as input to a hash algorithm: a configuration state 0^{S} 310 of the delegated computing device when performing the computation and the hash key 301 (ht.hk).

At step 526 of method 500, proof generation engine 112 then computes a delegation proof certificate 312 (del.π) and the proof-bit b 148 using as input to a proving algorithm: del.crs 202, public-data string x_{pb} as an instance value, and an aggregation of private-data string xₚᵣ 116 and 0^{S} 312 as witness value.

Public-hash digest h_{pb} 144, random value r 302, and encrypted private-hash-digest ehₚᵣ 304, configuration-state digest hi 308, and delegation proof certificate del.π 312, or the lengths thereof, may then be transmitted to setup engine 130 for generation of encryption sub-common-reference-string portion zk.crs_{edel} 214 and

$${n}_{edel}^{′}$$

216. Setup engine 130 then returns encryption sub-common-reference-string portion zk.crs_{edel} 214 to proof generation engine 112 for further processing and generation of proof output.

At step 528 of method 500, proof generation engine 112 may compute a second computational proof yielding proof certificate zk.π_{edel} 314 using, as input to a computational proving algorithm (which may be based on a NIZK scheme): the computation-proof sub-common reference string z_{edel} 212, instance element based on: the public-hash digest h_{pb} 144, the encrypted private-hash-digest ehₚᵣ 304, the configuration-state digest hi 308, and the proof-bit element b 148; and a witness element based on: the private-hash digest hₚᵣ 146, the random value r 302, and the delegation proof certificate del.π. Of note, proof certificate zk.π_{edel} 314 is shown within proof certificate 124 in FIG. 3 because proof certificate zk.π_{edel} 314 is an example of proof certificate 124.

The proof output 122 in the encrypted RAM delegation scheme implemented by proof generation engine 112 is then an accumulation of: proof-bit b 148, encrypted private-hash-digest ehₚᵣ 304, delegation proof certificate del.π 312, and proof certificate zk.π_{edel} 314. At step 530, proof output 122 is transmitted from delegated computing device 106 to client device 108.

### Encrypted RAM Delegation—VERIFY

To implement the verify algorithm in response to receipt of proof output 122 from proof generation engine 112, with enhanced encrypted RAM delegation, the verifier engine 126 implements the following, which is an example description of step 532 of method 500 and associated sub-steps 534, 536, and 538.

At step 534 of method 500, corresponding verifier engine 126 receives CRS 232 from setup engine 130. As discussed above, this may occur at a single time (e.g., after receiving proof output 122), or intermittently as the subcomponents of CRS 232 are generated.

At step 536 of 500, verifier engine 126 may compute a configuration-state digest 402 (h_{Σ}) using as input to a hash algorithm: a configuration state 0^{S} 310 of the delegated computing device when performing the computation and the hash key 301 (ht.hk). Alternatively, h_{Σ}308 may be received from proof generation engine 112.

At step 538 of method 500, corresponding verifier engine 126 generates a verification output to ensure the integrity and validity of the proof output 122. The function takes as input: the encryption sub-common-reference-string portion zk.crs_{enc} 206; a tuple consisting of public-data string x_{pb} 114, encrypted private-hash-digest ehₚᵣ 304, configuration-state digest 402 (h_{Σ}), and proof-bit b 148; and the proof certificate zk.π_{edel} 314. If the verification is successful, the function returns 1 as verification output 404, indicating that the proof is valid. Otherwise, the function outputs 0 as verification output 404, signifying that the proof is invalid.

As discussed above, the proof output 122 of the present embodiments allow for the following properties: completeness, efficiency, input hiding, soundness, and straight-line extraction. These properties are allowed for the proof output 122 generated by the encrypted RAM delegation scheme discussed with respect to FIGS. 2-5 above, as well. For example, regarding Input Hiding, the proof hides all the information about the private-data string xₚᵣ 116 by the security of the encryption scheme implemented at step 518 and the NIZK proof. Regarding straight-line extraction, if the underlying NIZKs have straight-line extraction, then, we can extract some

$${x}_{pr}^{*} ,$$

check it is consistent with ehₚᵣ, then extract the witness from zk.π_{edel}, use the correctness of the encryption to argue the consistency of the extracted

$${h}_{pr}^{*}$$

(from zk.π_{edel}) and

$${x}_{pr}^{*} ,$$

and finally rely on the security of the RAM delegation scheme to argue that

$$( {X}_{pb} , {x}_{pr}^{*} ) ∈ {ℒ}_{ℳ , T} .$$

Regarding efficiency, the size of all the hash values is λ bits, thus |ehₚᵣ|=poly(λ), and |π_{enc}|=poly(λ, |xₚᵣ|). Additionally, by the efficiency of the RAM delegation |del.π|=poly(λ, log T, log |x_{pb}, |log|xₚᵣ|), thus π_{edel} is of the same size. The efficiency of the verification time follows the same argument.

Indeed, the encrypted RAM delegation scheme allows for the following assumptions: Assuming either Learning With Errors (LWE), k-Linear Assumption (k-LIN) over pairing groups for any constant k∈ [symbol] or subexponential Decisional Diffie-Hellman (DDH) over pairing-free groups while still satisfying efficiency, straight-line extractor, input hiding properties.

### Reusable Encrypted Ram Delegation

The above-described encrypted RAM delegation also provides for reusable proofs. the encrypted RAM delegation, already satisfies reusability. Namely, ehₚᵣ and π_{enc} are generated independent of the x_{pb} and machine M, thus once they are generated, a prover can use aux=(xₚᵣ,r) in addition to x_{pb} to generate zk.π_{edel}.

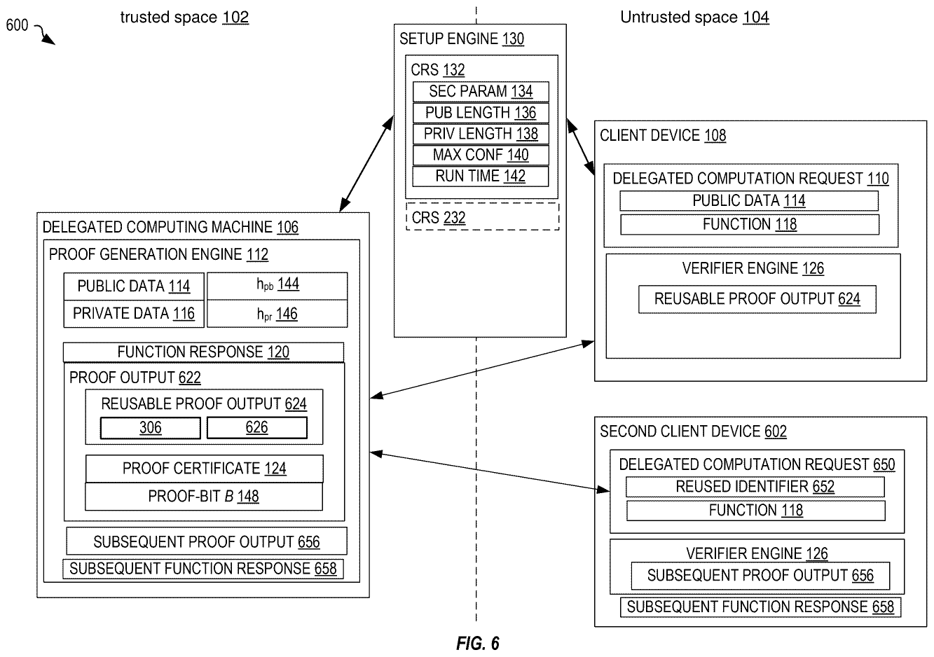

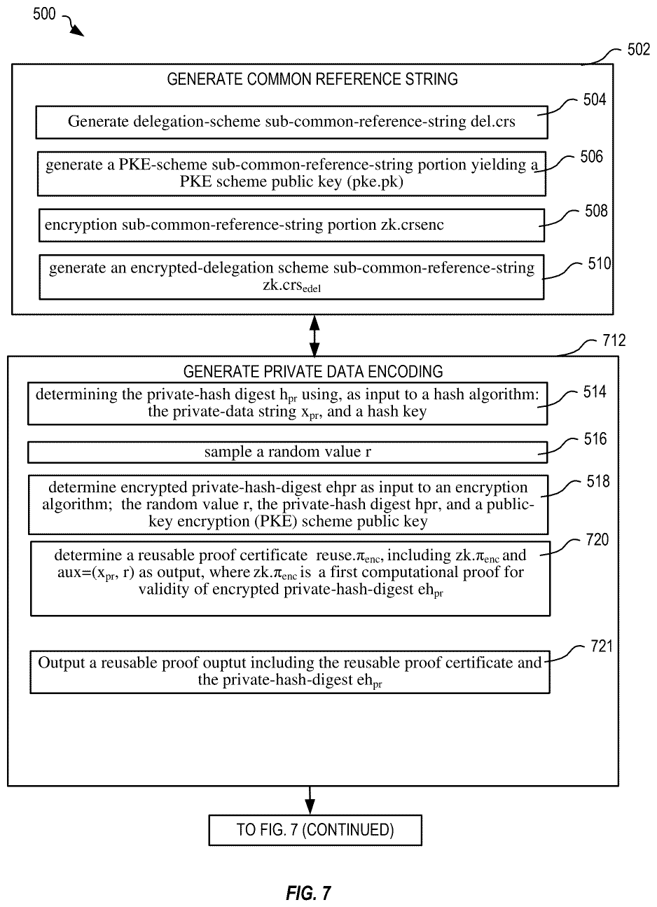

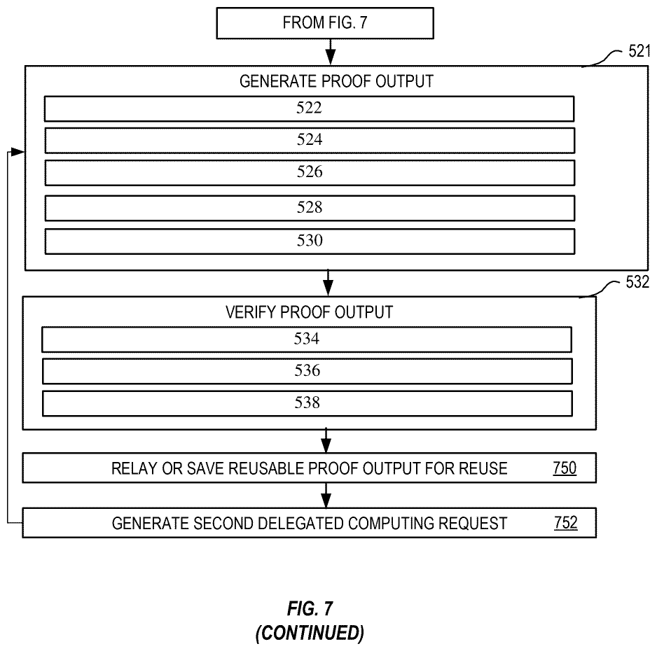

FIG. 6 shows system 600 including a reusable proof 604, in embodiments. Shows system 600 is the same as system 100, but includes a second client device 602. FIG. 7 shows an example method 700 for encrypted RAM delegation with reusable proof, in an embodiment implemented by the system 600, and particularly using the components shown in FIG. 6. Second client device 602 is similar to client device 108, and there may be more than one second client device 602 that uses a reusable proof 604, or iteration thereof, without departing from scope hereof.

Method 700 uses the same CRS as created in method 500, and therefore method 700 also includes step 502 and associated sub-steps 504, 506, 508, and 510. Step 712 in method 700 includes is similar to step 512 in method 500, and includes sub-step 514, 516, and 518 which are the same as method 500 and the discussion above of these sub-steps applies here. However, step 712, unlike step 512, does not include step 520, which is replaced with sub-steps 720 and 721. In sub-step 720, method 700 computes a reusable proof certificate 624, reuse.π_{enc}. Reusable proof certificate 624, reuse.π_{enc}, includes as output zk.π_{enc} 306 and aux=(xₚᵣ, r) as output, where zk.π_{enc} is a first computational proof certificate generated using as input to a NIZK proving algorithm; ZK.crs_{enc} 206 parsed from CRS 232; encrypted private-hash-digest ehₚᵣ 304 as the instance value in the NIZK proving algorithm; and, as the witness value to the NIZK proving algorithm, an aggregation of: the private-data string xₚᵣ 116, private-hash digest hₚᵣ 146, and the random value r 302. This yields first delegation proof certificate zk.π_{enc} 306. Differing from step 520, step 720 also outputs an auxiliary value 626, aux, which is based on the private-data string xₚᵣ 116 and the random value r 302. Reusable proof certificate 624 and/or auxiliary value 626 is further stored in memory of delegated computing device 106 for further use, thereby eliminating cost required by delegated computing device 106 to recreate encoding proof certificates on the same private data.

For the first iteration of method 700, in response to the first delegated computation request 110 requesting computation using private-data string xₚᵣ 116, method 700 may implement step 521 including sub-steps 522, 524, 526, 528, and 530 and the discussion above of these sub-steps applies here. Correspondingly, method 700 may implement step 532 including sub-steps 534, 536, and 538 and the discussion above of these sub-steps applies here.

However, as discussed above, FIGS. 6 and 7 allow for reusability to reduce the needed computational steps for repeated computations based on the same private input. Therefore, method 700 further includes step 750. At step 750, the reusable proof output 624, or a portion thereof such as first delegation proof certificate zk.-enc 306 and/or reusable proof certificate 624 are relayed to a second client device 602 or saved in memory of delegated computing device 106. The second client device 602 or delegated computing device 106 then generates, at step 752, another delegated computation request 650 which is received by delegated computing device 106, or another machine associated therewith. Delegated computation request 650 includes a reused identifier 652 of the private-data string xₚᵣ 116, such as one or more of first delegation proof certificate zk.π_{enc} 306, reusable proof certificate 624, or auxiliary value 626 and identification of the public data associated with the computation requested as well as the desired function 654 to be calculated, where the public data may be the same as public-data string x_{pb} 114, or different and/or where the machine performing the calculation on desired function 654 may be the same or different.

In response to receipt of the another delegated computation request 650, delegated computing device 106 (or the requested different machine) repeats step 521 in method 700 to generate a subsequent proof output 656 associated with a subsequent function response 658 which is the answer to the desired function 654. Advantageously, because the another delegated computation request 650 included identifier of the private-data string xpr 116 to which the reusable proof certificate 624 was based upon, delegated computing device 106 (or the different machine) can reuse the previously-determined zk.π_{enc} generated at step 720 in method 700, thereby significantly reducing the computational cost and time associated with the generation of subsequent proof output 656. This efficiency scales with the number of future delegation requests based on the same allotted private-data string xₚᵣ 116.

Furthermore, the system and method of FIGS. 6 and 7 allow for the following properties even with reusable and subsequent proof outputs: completeness, efficiency, input hiding, soundness, and straight-line extraction.

### Rate-1 NIZK Scheme

A non-interactive zero knowledge argument system (NIZK) fora non-deterministic polynomial-time (NP) language L is a standard two-party proof system defined in the CRS model, where a prover wants to convince a verifier that an instance x∈L, without the revealing any information about the corresponding witness ω. All parties have access to a public crs. Soundness states that any polytime cheating prover should not be able to convince the verifier of a false assertion, while zero-knowledge requires that the proof string w should be simulatable given just a valid instance x. A stronger notion of knowledge soundness requires the system to additionally support efficient extraction of a valid witness ω from any accepting proof π for an instance x. NIZKs are a fantastic and fundamental cryptographic tool with numerous applications across cryptography.

Almost all NIZK systems built from standard tools result in proofs and CRS of large size. That is, |π|, |crs|=poly(λ, |x|, |ω|). In particular, the proof size is much larger than the witness size, |ω|. Rate-1 NIZK herein refers to the fact that |π|=|ω|+poly(λ). Prior work, however, crucially relies on fully-homomorphic encryption (FH E) to perform hybrid encryption to reduce the proof size. Thus, despite the fact that the community has developed multiple approaches for designing NIZKs from a variety of standard tools and assumptions over the last 30+ years, the only known construction we have for rate-1 NIZKs relies on learning with errors (LWE) assumption.

The below discussion provides to generate a NIZK proof for instance x with witness ω, starting by encrypting ω using a one-time pad key K, where K could be computed as the output of a pseudorandom generator on a random, but fixed size, seed sd. Now the NIZK proof can be generated by running the encrypted RAM delegation discussed above with x_{pb}:=(x,ω⊕K) and xₚᵣ:=sd. This results in a proof π that can be verified given just x_{pb}. That is, a verifier does not need xₚᵣ. Therefore, the NIZK proof can be set as π and the one-time pad encryption of ω, i.e. ω⊕K. Clearly, the verifier can run the encrypted RAM delegation verified algorithm to check the validity of the proof.

The fact that the resulting NIZK proof is rate-1 follows immediately from the fact that one-time pad K is rate-1 and the proof size in encrypted RAM delegation does not grow with X_{pb}, but only xₚᵣ which is of fixed size (say λ). For zero-knowledge, a simple hybrid argument first relies on the input hiding property of encrypted RAM delegation proof, and then uses a one-time pad encryption argument to remove any remaining information about ω. Lastly, for knowledge soundness, the extraction soundness property for encrypted RAM delegation recovers the seed sd and uses it to extract the witness ω. At its core, the above-discussed encrypted RAM delegation scheme uses a poor-rate NIZK scheme to guarantee the input hiding property, thus if the underlying zero-knowledge property is statistical, then so is the zero-knowledge guarantee of our rate-1 NIZKs.

The above construction works for any scheme with an a priori bounded size witness. We can instead handle unbounded length witnesses quite easily by rather leveraging a pseudorandom function instead of a pseudorandom generator.

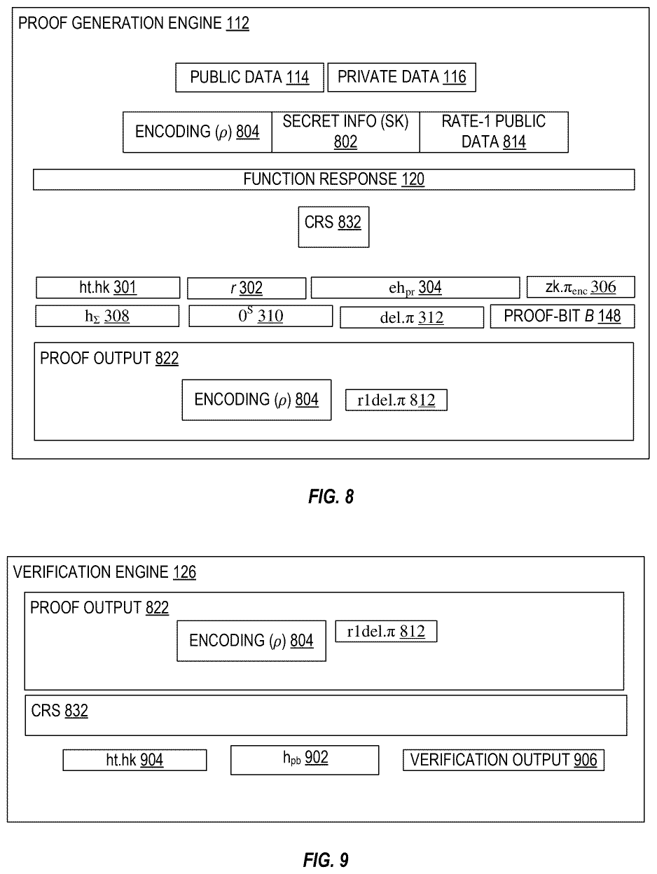

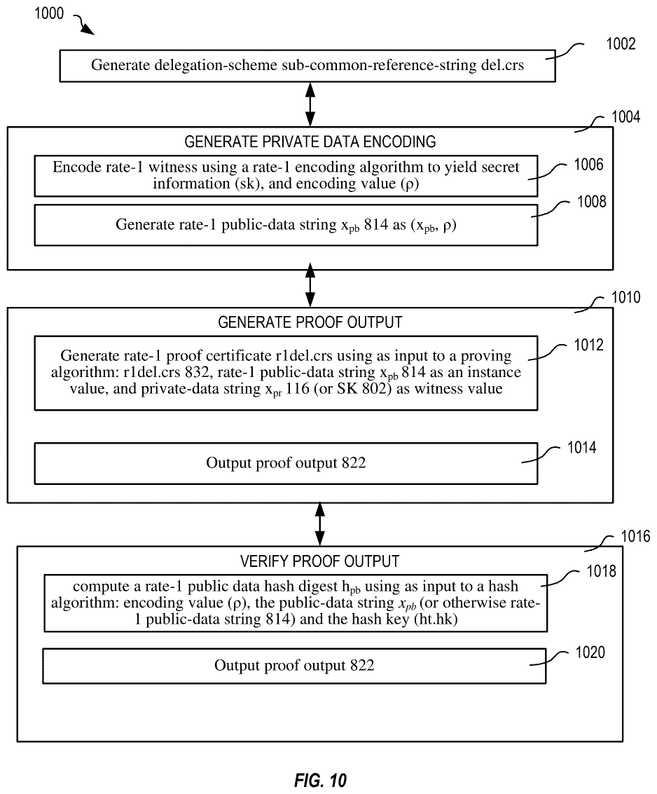

FIG. 8 shows proof generation engine 112 in further detail used to implement encrypted RAM delegation with rate-1 characteristic. FIG. 9 shows verifier engine 126 including data to implement rate-1 encrypted RAM delegation. FIG. 10 shows an example method 1000 for rate-1 encrypted RAM delegation, in an embodiment implemented by the system 100, and particularly using the components shown in FIGS. 2 and 8. FIGS. 2, and 8-10 are viewed together with the following description.

A rate-1 message encoding of a string x∈{0,1}* is an encoding p of the same length asx and secret information sk. However, for any PPT adversary without the sk, the encoding should look indistinguishable from a random string. As used herein, a rate-1 message encoding scheme is as follows:

A rate-1 message encoding scheme (r1Enc) for any x consists of the following polynomial time algorithms:

Encode(1^{λ},x)→(ρ,sk). The probabilistic encoding algorithm takes as input a security parameter λ, a string x, outputs the encoding p, and the secret information sk.

Decode(1^{λ}, ρ, sk)→y. The decoding algorithm takes as input the security parameter λ, encoded string ρ, the secret information sk, and outputs a string y.

### Rate-1 Encrypted RAM Delegation-SETUP

The setup step 1002 of method 1000 is the same as step 1004 of method 500. Therefore, the above-discussion of step 1004 is repeated and applies here as well and thus generates crs 832.

### Rate-1 Encrypted RAM Delegation—PROVE

At step 1004, method 1000 generates private data encoding using a rate-1 encoding algorithm (referred to as r1Enc.Encod(1λ, w)). In sub-step 1006, method 1000 uses rate-1 encoding algorithm, where λ is security parameter λ 134 to yield (ρ, sk) is an encoding value 804, and sk is a secret information 802. In an embodiment sub-step 1006 includes setting secret information (sk) 802 as private-data string xₚᵣ 116 for use in the above RAM delegation and reusable RAM delegation functionalities which yields an encoding value 804 of private-data string xₚᵣ 116.

Public-data string X_{pb} 114 and encoding value 804 are then combined in sub-step 1008 to define rate-1 public-data string x_{pb} 814 as (x_{pb}, φ. Because encoding value 804 is an encoded data string based on private-data string xₚᵣ 116, the information of private-data string xₚᵣ 116 is not shared even if rate-1 public-data string x_{pb} 814 is shared and thus encoding value 804 and rate-1 public-data string x_{pb} 814 are sharable without compromising security.

Method 1000 then generates a proof output in step 1010 as follows. At sub-step 1012, proof generation engine 112 computes a rate-1 delegation proof certificate 812 (r1del.π) using as input to a proving algorithm: r1del.crs 832, rate-1 public-data string x_{pb} 814 as an instance value, and private-data string xₚᵣ 116 (or SK 802) as witness value.

The generated proof output 822 is sent to client device 108 including encoding 804 and rate-1 delegation proof certificate 812 (r1del.n).

### Rate-1 Encrypted RAM Delegation—VERIFY

At step 1016, method 1000 verifies the proof output 822 received from delegated computing device 106. Sub-step 1018, verifier engine 126 computes a rate-1 public data hash digest h_{pb} 902 using as input to a hash algorithm: encoding value (ρ) 804, the public-data string x_{pb} (or otherwise rate-1 public-data string 814) and a hash key (ht.hk) 904. At sub-step 1020, verifier engine 126 takes as input to a verification algorithm the common reference string crs 832, the calculated rate-1 public data hash digest h_{pb} 902, the encoding value (ρ) 804, and the rate-1 delegation proof certificate 812 (r1del.π) to generate verification output 906. Verification output 906 may be a 0 (reject) or 1 (accept).

### Rate-1 Encrypted RAM Delegation

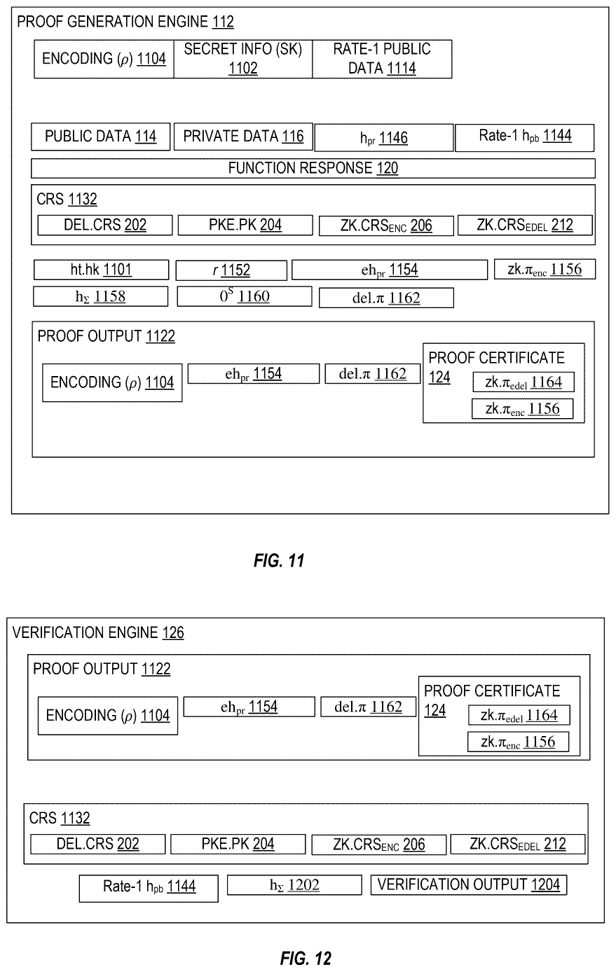

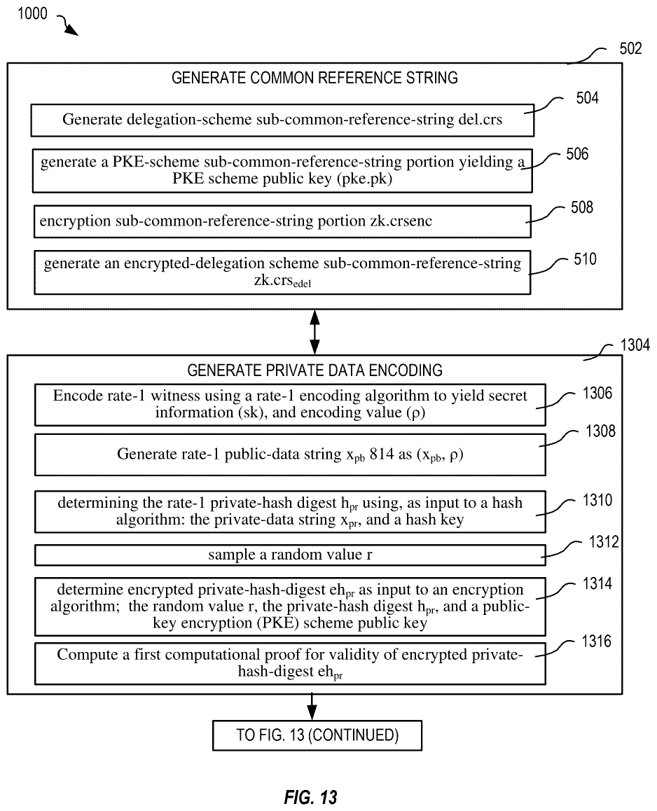

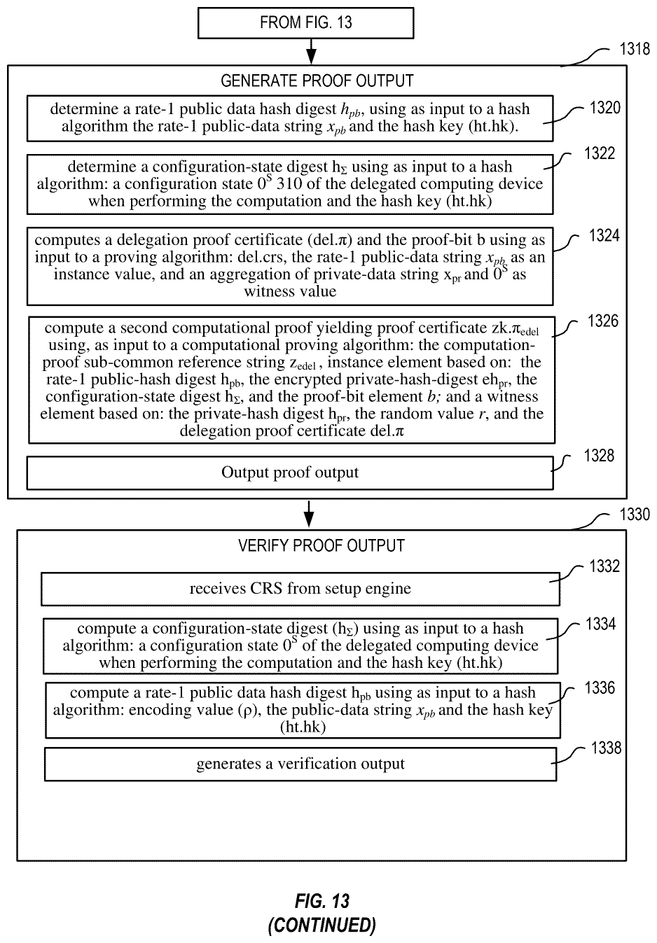

The above-discussed Rate-1 functionality discussed with respect to FIGS. 8-10 may be applied to the other embodiments herein, such as the encrypted RAM delegation and the reusable encrypted RAM delegation. FIG. 11 shows proof generation engine 112 in further detail used to implement encrypted RAM delegation with rate-1 characteristic. FIG. 12 shows verifier engine 126 including data to implement rate-1 encrypted RAM delegation. FIG. 13 shows an example method 1300 for rate-1 encrypted RAM delegation, in an embodiment implemented by the system 100, and particularly using the components shown in FIGS. 11-12. FIGS. 11-13 are viewed together with the following description.

### Rate-1 Encrypted RAM Delegation—SETUP

Method 1300 includes setup step 502 and associated sub-steps discussed in FIG. 5, the discussion of which applies here as well and thus generates crs 1132 including del.crs 202, PKE scheme public key 204, zk.crs_{enc} 206, and zk.crse_{del} 212.

### Rate-1 Encrypted RAM Delegation—ENCODE/PROVE

To implement the prove algorithm, with rate-1 enhanced encrypted RAM delegation, the proof generation engine 112 implements the following.

Similar to method 500, proof generation engine 112 receives CRS 232, or at least a sub-portion thereof, and parses into sub-components of the common reference string. For example, proof generation engine 112 may initially receive the del.crs 202 and PKE scheme public key 204 sub-components of CRS 232.

Step 1304 in method 1300 is similar to step 1004 in method 1000, but includes additional functionality to implement RAM delegation. At step 1304, method 1000 generates private data encoding using a rate-1 encoding algorithm (referred to as r1Enc.Encod(1λ, w)). In sub-step 1306, method 1300 uses rate-1 encoding algorithm, where X is security parameter λ 134 to yield (ρ, sk) is an encoding value 1104, and sk is a secret information 1102. In an embodiment sub-step 1306 includes setting secret information (sk) 1102 as private-data string xₚr 116 which yields an encoding value 1104 of private-data string xₚr 116.

Public-data string x_{pb} 114 and encoding value 1104 are then combined in sub-step 1308 to define rate-1 public-data string x_{pb} 1114 as (x_{pb}, ρ). Because encoding value 1104 is an encoded data string based on private-data string xₚᵣ 116, the information of private-data string xₚᵣ 116 is not shared even if rate-1 public-data string x_{pb} 1114 is shared and thus encoding value 1104 and rate-1 public-data string x_{pb} 114 are sharable without compromising security.

Secret information 1102 and rate-1 public-data string x_{pb} 1114 are then used in an encrypted RAM delegation sub-steps in method 1300 as follows.

At step 1310 in method 1300, proof generation engine 112 computes a hash digest, e.g., private-hash digest hₚᵣ 1146, using as input to a hash algorithm the private-data string xₚᵣ 116 and a hash key 1101 (ht.hk), which is similar to hash key 301 and may be transmitted to proof generation engine 112 from setup engine 130, another device, or predetermined between delegated computing device 106 and client device 108. At step 1312 in method 1300, proof generation engine 112 may further sample a random value r 1152, which is similar to random value r 302. At step 1314 in method 1300, using random value 1152, and the PKE scheme public key 204 as input to an encryption algorithm, proof generation engine 112 may generate encrypted private-hash-digest ehₚᵣ 1154, which is similar to encrypted private-hash-digest ehpr 304.

At step 1316 of method 1300, proof generation engine 112 may compute a first NIZK proof certificate zk.π_{enc} for validity of the encrypted private-hash-digest ehₚᵣ 1154 using, as input to a NIZK proving algorithm: ZK.crs_{enc} 206 parsed from CRS 1132; encrypted private-hash-digest ehₚᵣ 1154 as the instance value in the NIZK proving algorithm; and, as the witness value to the NIZK proving algorithm, an aggregation of: the private-data string xₚᵣ 116 (or otherwise secret information SK 1102), private-hash digest hₚᵣ 1146, and the random value r 1152. This yields first delegation proof certificate zk.π_{enc} 1156.

Once the private data encoding step 1304 is completed, method 1300 continues by generating proof output 1122 at step 1318 including sub-steps 1320, 1322, 1324, 1326, and 1328.

Private-hash digest hₚᵣ 1146, random value r 1152, and encrypted private-hash-digest ehₚr 1154, or the lengths thereof, may then be transmitted to setup engine 130 for generation of encryption sub-common-reference-string portion zk.crs_{enc} 206 using as input: n_{enc} 208 defined as the length of an encrypted private-hash-digest ehₚᵣ 1154; n′_{enc} 210 defined as the length of the private-data string xₚᵣ 116 plus the length of the private-hash-digest hₚᵣ 1146 plus the random value r 1152. Setup engine 130 then returns encryption sub-common-reference-string portion zk.crs_{enc} 206 to proof generation engine 112 for further processing and generation of proof output.

At step 1320 of method 1300, proof generation engine 112 may compute a rate-1 public data hash digest h_{pb} 1144, similar to rate-1 public-hash digest h_{pb} 844, using as input to a hash algorithm the rate-1 public-data string x_{pb} 1114 and the hash key 1101 (ht.hk). At step 1322 in method 1300, proof generation engine 112 may compute a configuration-state digest hi 1158 using as input to a hash algorithm: a configuration state 0^{S} 1160 of the delegated computing device when performing the computation and the hash key 1101 (ht.hk).

At step 1324 in method 1300, proof generation engine 112 then computes a delegation proof certificate 1162 (del.π) using as input to a proving algorithm: del.crs 202, rate-1 public-data string x_{pb} 1114 as an instance value, and an aggregation of private-data string xₚᵣ 116 and 0^{S} 1160 as witness value.

Public-hash digest h_{pb} 1144, random value r 1152, and encrypted private-hash-digest ehₚᵣ 1154, configuration-state digest h_{Σ} 1158, and delegation proof certificate del.π 1162, or the lengths thereof, may then be transmitted to setup engine 130 for generation of encryption sub-common-reference-string portion zk.crs_{edel} 214 and

$${n}_{edel}^{′}$$

216. Setup engine 130 then returns encryption sub-common-reference-string portion zk.crs_{edel} 212 to proof generation engine 112 for further processing and generation of proof output.

At step 1326 in method 1300, proof generation engine 112 may compute a second computational proof yielding proof certificate zk.π_{edel} 1164 using, as input to a computational proving algorithm (which may be based on a NIZK scheme): the computation-proof sub-common reference string zk.crs_{edel} 212, instance element based on: the rate-1 public-hash digest h_{pb} 1144, the encrypted private-hash-digest ehₚᵣ 1154, the configuration-state digest h_{Σ} 1158, and the encoding value 1104; and a witness element based on: the private-hash digest hₚᵣ 1146, the random value r 1152, and the delegation proof certificate del.π 1162. Of note, proof certificate zk.π_{edel} 1164 is shown within proof certificate 1124 in FIG. 11 because proof certificate zk.π_{edel} 1164 is an example of proof certificate 124.

The proof output 1122 in the rate-1 encrypted RAM delegation scheme implemented by proof generation engine 112 is then an accumulation of: encrypted private-hash-digest ehₚᵣ 1154, encoding value 1104, delegation proof certificate del.π 1162, and proof certificate zk.π_{edel} 1164. At step 1328 of method 1300, proof output 1122 is transmitted from delegated computing device 106 to client device 108.

### Rate-1 Encrypted RAM Delegation—VERIFY

To implement the verify algorithm in response to receipt of proof output 1122 from proof generation engine 112, with rate-1 enhanced encrypted RAM delegation, the verifier engine 126 implements the following, which is an example description of step 1330 of method 1300 and associated sub-steps 534, 536, 1034, and 538.

At step 1332 in method 1300, verifier engine 126 receives CRS 1132 from setup engine 130. As discussed above, this may occur at a single time (e.g., after receiving proof output 122), or intermittently as the subcomponents of CRS 1132 are generated.

At step 1334 in method 1300, verifier engine 126 may compute a configuration-state digest 1202 (h_{Σ}) using as input to a hash algorithm: a configuration state 0^{S} 1160 of the delegated computing device when performing the computation and the hash key 1101 (ht.hk). Alternatively, h_{Σ} 1202 may be received from proof generation engine 112.

In step 1336 in method 1300 corresponding verifier engine 126 computes a rate-1 public data hash digest h_{pb} 1144 using as input to a hash algorithm: the rate-1 public-data string X_{pb} 1114 and the hash key 1101 (ht.hk).

At step 1338 in method 1300, corresponding verifier engine 126 generates a verification output to ensure the integrity and validity of the proof output 1122. The function takes as input: the encryption sub-common-reference-string portion zk.crs_{enc} 206; a tuple consisting of rate-1 public data hash digest h_{pb} 1144 calculated in step 1336, encrypted private-hash-digest ehₚᵣ 1154 received as part of proof output 1122, configuration-state digest 1202 (h_{Σ}), and encoding value 1104; and the proof certificate zk.π_{edel} 1164. If the verification is successful, the function returns 1 as verification output 1204, indicating that the proof is valid. Otherwise, the function outputs 0 as verification output 1204, signifying that the proof is invalid.

zk.π_{enc} 1156 is reusable in similar way that reused identifier 652 is reusable as discussed above.

Furthermore, rate-1 reusable encrypted RAM delegation (and reusable encrypted RAM delegation) functionality allows for rate-1 characteristic while satisfying completeness, efficiency, input hiding, soundness, computational zero knowledge, and straight-line extraction properties. Moreover, the running time of verifier can reduced by considering a preprocessing phase where x,ρ (parsed from del.π) are hashed independent of Verify. This renders the running time of Verify to be virtually independent of |x| and |w|. In addition, due to the polylogarithmic dependence |crs| and Setup algorithm's running time T, we can parse λ many crs with exponentially increasing T, i.e, T=1, . . . , T=2λ and use the crs that appropriately bounds the running time of A. This is the popular powers-of-2 technique which is used in various contexts to reduce/remove the dependency of certain parameters in the analysis of algorithm which depend poly-logarithmically in the length of said parameters.

Rate Preserving Maliciously Secure Multiparty Non-Interactive Secure Computation (mrNISC) Scheme

The above-discussed features of rate-1 and reusable encrypted RAM delegation enables the ability to provide a Rate Preserving Maliciously Secure multiparty non-interactive secure computation (mrNISC) scheme. Organizations can use a maliciously secure mrNISC scheme to perform joint data analysis on sensitive datasets without revealing the underlying data to each other. This is particularly useful in healthcare, finance, and other industries where data privacy is paramount.

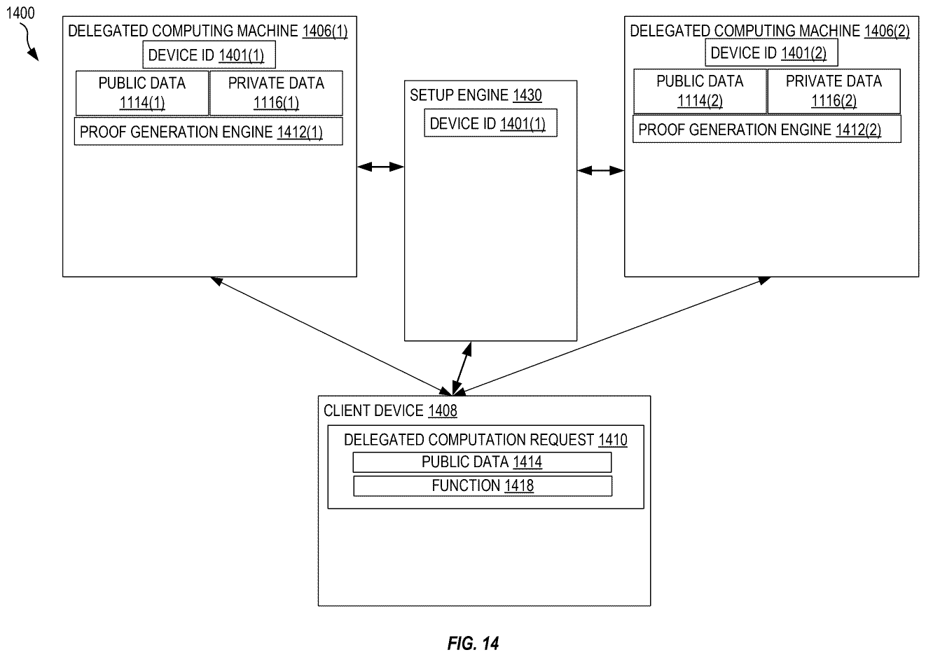

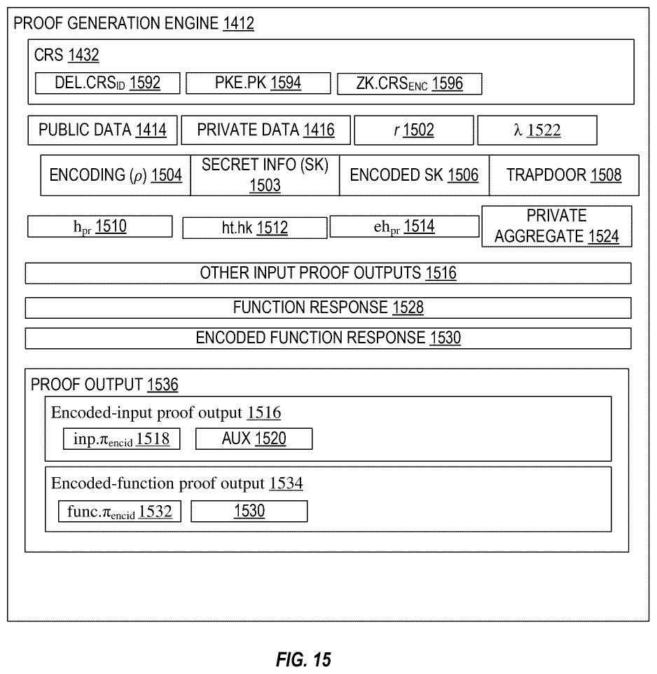

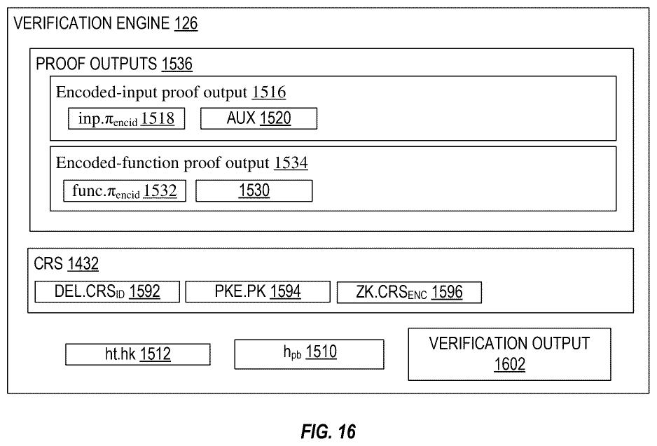

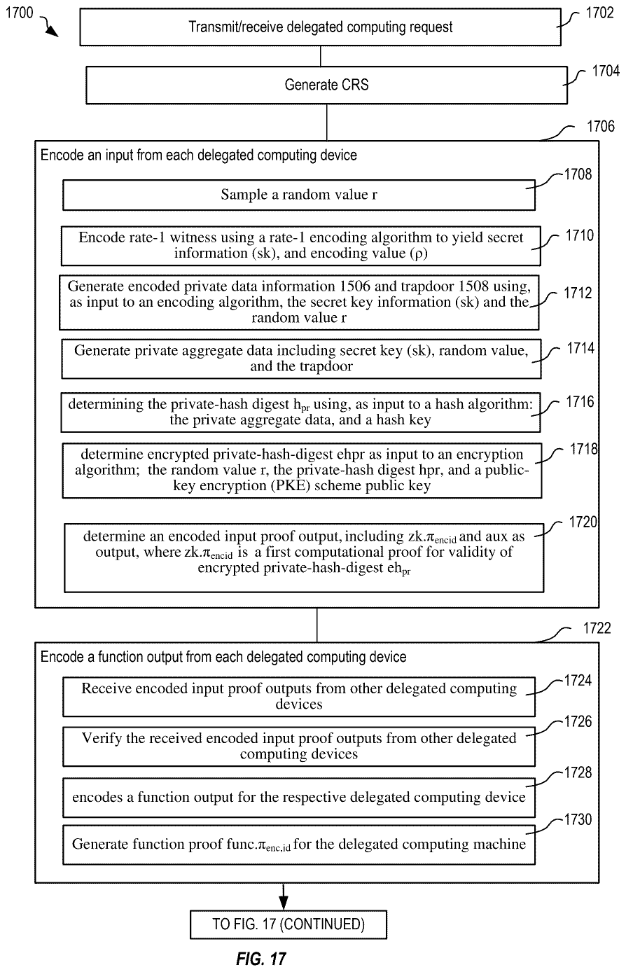

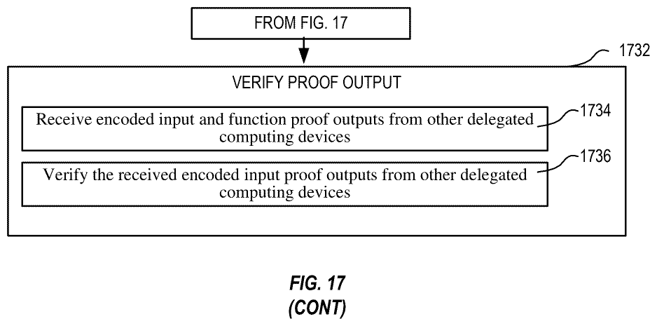

FIG. 14 shows a system 1400 for encrypted RAM delegation that implements Rate Preserving Maliciously Secure multiparty non-interactive secure computation (mrNISC) scheme, in an embodiment. System 1400 may use any feature of FIGS. 1-13 discussed above, and in particular implements the following functionality. FIG. 15 shows the proof generation engine 1412 of each delegated computing machine 1406 in further detail. FIG. 16 shows the verifier engine 1426 of the client device 1408 in further detail. FIG. 17 shows a method 1700 that implements Rate Preserving Maliciously Secure multiparty non-interactive secure computation (mrNISC) scheme using system 1400, in an embodiment. FIGS. 14-17 are best viewed together with the following description.

System 1400 includes a client device 1408 that generates a computation request 1410 to be completed by each of a plurality of delegated computing machines 1406, shown including a first delegated computing machine 1406(1) and a second delegated computing machine 1406(2). Client device 1408 is an example of client device 108 and each delegated computing machine 1406 is an example of delegated computing device 106 discussed above. There may be more delegated computing machines 1406 without departing from scope hereof. Therefore, each delegated computing machine 1406 includes a proof generation engine 1412. First delegated computing machine 1406(1) is shown with first public data string x_{pb1} 1414(1) and first private data string xₚᵣ₁ 1416(1), and second delegated computing machine 1406(2) is shown with second public data string xₚᵣ₂ 1414(2) and second private data string xₚᵣ₂ 1416(2). The public data strings 1414 may be the same or different across each of the delegated computing machines 1406.

Client device 1408 initiates, at step 1702 of method 1700, the mrNISC scheme by transmitting a delegated computation request 1410.

mrNISC—SETUP

Method 1700 includes generating a CRS 1432 at step 1704. Each delegated computing device 1406 receives a dedicated CRS 1432 from setup engine 1430, which is similar to setup engine 130 discussed above. First delegated computing machine 1406(1) is shown with first CRS 1432(1) and second delegated computing machine 1406(2) is shown with second CRS 1432(2), and each CRS 1432 is associated with the respective device ID 1401. To generate CRS 1432, setup engine 1430 samples a reusable encrypted RAM delegation crs for each id∈[n], del.crs_{id}←rEDel.Setup(1^{λ}, 1^{lpr}) where [symbol] ₚᵣ is the maximum length of the private input for MSC across all n parties (where “id” is respective device ID 1401 and the parties are each delegated computing machine 1406). CRS 1432 therefore is as follows: crs=(del.crs_{id})_{id∈[n]}. CRS 1432 may include sub-crs information, including an aggregate of del.crs_{id} 1592, PKE scheme public key 1594, zk.crs_{enc} 1596 and zk.crs_{edel} 1598.

### Mrnisc—Prove

The prove functionality of method 1700 includes features from the rate-1 functionality and reusable encrypted RAM delegation functionality discussed above. The prove functionality includes a sub-step 1706 of encoding an input from each delegated computing device. At sub-step 1708, method 1700 samples a random value r 1502. In one embodiment, random value r 1502 is sampled from 0 to 1 to the power of the length of the private data 1416 of the given delegated computing machine 1406.

At sub-step 1710, method 1700 encode rate-1 witness using, as input to a rate-1 encoding algorithm, the private data string 1416 of the respective delegated computing machine 1406 and the security parameter a security parameter λ 1522, which is an example of security parameter 134 to yield secret information (sk) 1503, and encoding value (ρ) 1504.

At sub-step 1712, method 1700 generates encoded private data information (SMSC. [symbol] _{id}) 1506 and trapdoor 1508 by inputting to an encoding algorithm the secret key information 1503 and the random value 1502.

At sub-step 1714, method 1700 generates a private aggregate value 1524 based on the secret information (sk) 1503, random value r 1502, and the trapdoor 1508.

At sub-step 1716, which is similar to step 514, method 1700 determines a private-hash digest hₚᵣ 1510 using, as input to a hash algorithm: the private aggregate value 1524 of the respective delegated computing machine 1406 and a hash key 1512, which is similar to hash key 301.

At sub-step 1718, which is similar to step 516, method 1700 determine encrypted private-hash-digest ehₚᵣ 1514 as input to an encryption algorithm; the random value r 1502, the private-hash digest hpr 1510, and a public-key encryption (PKE) scheme public key 1594.

At step 1720, which is similar to sub-step 720, method 1700 determines a device-specific encoded input proof output 1516. Encoded input proof output 1516 includes an aggregate of encoding value (ρ) 1504, private data information (SMSC. [symbol] _{id}) 1506, private-hash-digest ehₚᵣ 1514, and zk.π_{encid} 1518; where zk.π_{encid} 1518 is a first computational proof certificate generated using as input to a NIZK proving algorithm: ZK.crs_{enc} 1596 parsed from CRS 1432; encrypted private-hash-digest ehₚᵣ 1514 as the instance value in the NIZK proving algorithm; and, as the witness value to the NIZK proving algorithm, an aggregation of: private aggregate value 1524 and the private-hash digest hₚᵣ 1510. The trapdoor 1508 is utilized as the aux value.

Method 1700 further includes a function encoding algorithm at step 1722. Step 1722 allows for each delegated computing device 1406 to use the proof output from other of the each delegated computing devices 1406 to generate its full response to the delegated computing request 1410. Accordingly, at step 1724, each delegated computing machine 1406 receives, from the other delegated computing machines 1406 the respective encoded input proof outputs 1516 generated during step 1706 of method 1700.

At sub-step 1726, method 1700 verifies the received encoded input proof outputs 1516 to ensure a malicious party has not intervened in the method. The verification function is run for each received input proof outputs 1516 and takes as input: the respective encryption sub-common-reference-string portion zk.crs_{enc} 1595; the respective encrypted private-hash-digest ehₚᵣ 1514 (which may be redetermined by the device implementing sub-step 1726; and the respective proof certificate inp.π_{enc,id} 1518. If the verification is successful, the function proceeds with sub-step 1728, else the device implementing sub-step 1726 operates to abort the calculation and report an error or malicious information indication to client device 1408 and/or a system administrator.

At sub-step 1728, method 1700 encodes a function output 1528 for the respective delegated computing machine 1406 using, as input to an encoding algorithm, the device ID 1401, an aggregate of each received encoded private data information (SMSC. [symbol] _{id}) 1506 from the other delegated computing machine(s) 1406, an encoded trapdoor 1508 of the device performing sub-step 1728, and the random value 1502. Sub-step 1728 yields encoded function output 1538.

At sub-step 1730, method 1700 generates a function proof func.π_{enc,id} 1532 for the delegated computing machine 1406 by inputting, to a proving algorithm (such as a NIZK proving algorithm): Del.crs_{id} 1592 of the device implementing sub-step 1730; an aggregation of the device ID 1401, the function response 1528, an aggregate of each received encoded private data information (SMSC. [symbol] _{id}) 1506 from the other delegated computing machine(s) 1406, and the encoded function response (SMSC.ĝ_{id}) 1530 as instance value; and the trapdoor 1508 as witness.

Step 1732 is operated by client device 1408 to verify the input proof outputs 1516 and an encoded function proof output 1534 generated by each of the delegated computing machine 1406.

At step 1734, the input proof outputs 1516 and an encoded function proof output 1534, including function proof func.π_{enc,id} 1532 and the encoded function response (SMSC.ĝ_{id}) 1530 are combined (or separately sent) as proof output 1536 and sent to/received by client device 1408.

At step 1736, method 1700 verifies the received encoded input proof outputs 1516 to ensure a malicious party has not intervened in the method. The verification function is run for each received input proof outputs 1516 and takes as input: the respective encryption sub-common-reference-string portion zk.crs_{enc,id} 1595; the respective encrypted private-hash-digest eh_{pr,id} 1514 (which may be redetermined by the device implementing sub-step 1726; and the respective proof certificate inp.π_{enc,id} 1518. If the verification is successful, the function proceeds with sub-step 1738, else the device implementing sub-step 1736 operates to abort the calculation and report an error or malicious information indication to client device 1408 and/or a system administrator.

A t step 1738, method 1700 validates the received encoded input proof outputs 1516 and encoded function proof output 1534 received from each delegated computing machine 1406. The validation result is output as verification output 1602. Output SMSC.Eval(g, {(SMSC. [symbol] _{id})}id, {(SMSC.ĝ_{id})}id).

Therefore, to evaluate f, the evaluator checks that the proofs from all parties verify, and then it uses the semi-malicious evaluator to learn the output of the computation. In a nutshell, the semimalicious security of the underlying mrNISC protocol, and knowledge soundness and input-hiding property of the above-discussed reusable encrypted RAM delegation gives a maliciously secure mrNISC protocol. The direct compiler is only nearly rate-preserving due to the decommitment information's dependence on the length of input x.

### Homomorphic Nizk Proof Creation

In the following, system 100 may additionally support an unbounded homomorphic NIZK, which we call truly fully homomorphic NIZK, built upon the above-discussed rate-1 NIZK features. The homomorphic NIZK primitive enables homomorphic evaluations on top of multiple proofs to generate a composite NIZK proof. Unlike a standard NIZK scheme, a homomorphic NIZK includes an additional algorithm (Eval) that takes as input crs,C,{(Cⱼ, bⱼ, πⱼ)}_{j∈[k]} and outputs C′, b, π for C′ as the composition of C, C₁, . . . , Cₖ. An additional advantageous property of the below-discussed homomorphic NIZK is unlinkability: the evaluated proof π for the instance (C′, b) must be indistinguishable from a freshly generated proof using a witness ω such that C′(ω)=b. Moreover, the design inherently supports unbounded circuit sizes and evaluation hops. The following description provides a NIZK for circuit satisfiability by generating a sequence of gate-by-gate NIZK proofs under a single CRS.

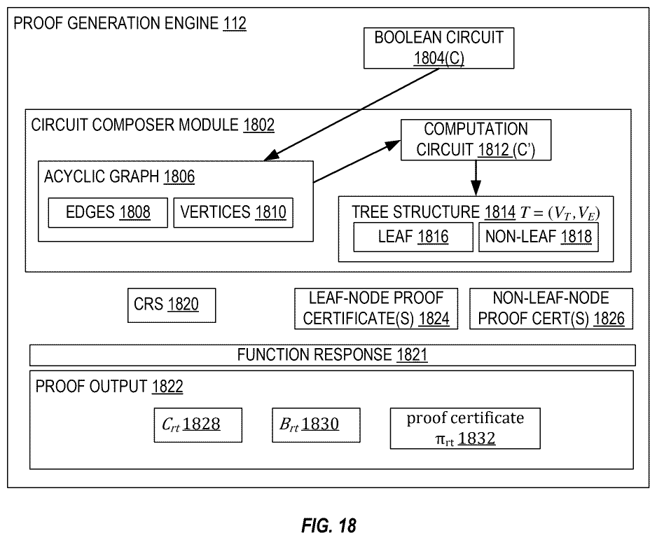

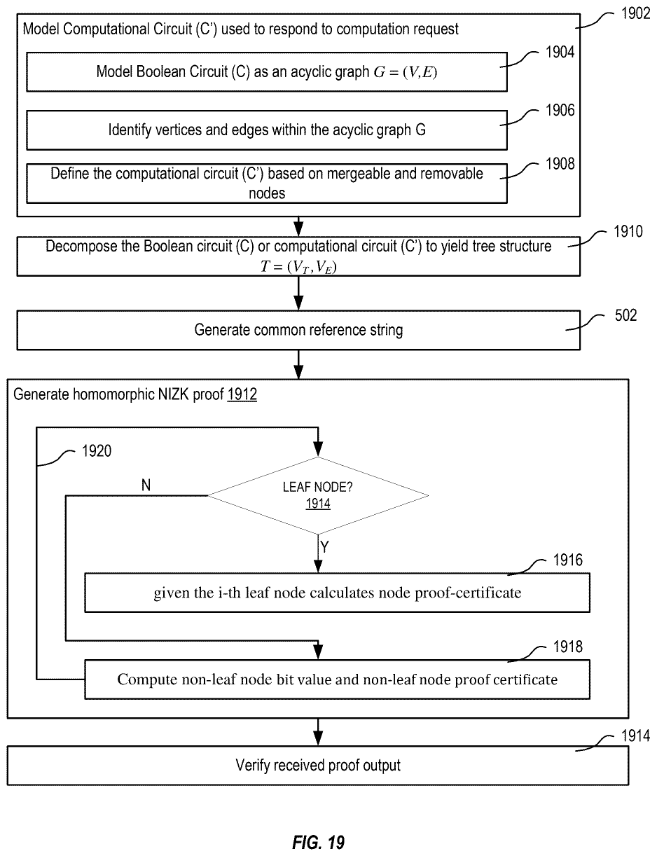

FIG. 18 shows proof generation engine 112 and associated functionality to implement an unbounded homomorphic NIZK scheme for RAM delegation, in an embodiment. FIG. 19 depicts a method 1900 for homomorphic NIZK implementation, in an embodiment. Features in FIGS. 18-19 may be incorporated into any of the embodiment discussed above without departing from scope hereof.

To implement unbounded homomorphic NIZK scheme for RAM delegation, system 100 may further include a circuit composer module 1802. Circuit composer module 1802 operates at step 1902 of method 1900 to model a computational circuit (C′) used to respond to a computation request from client device 108. An example of circuit composer module 1802 is discussed in Prabhanjan Ananth, Apoorvaa Deshpande, Yael Tauman Kalai, and Anna Lysyanskaya, “Fully homomorphic NIZK and NIWI proofs.”, Theory of Cryptography Conference, pages 356-385, 2019, which is incorporated by reference herein.

Step 1902 may have sub steps 1904, 1906, and 1908. Sub-steps 1904, 1906, and 1908 are repeated for each sub-circuit in Boolean circuit 1804.

As discussed above, the delegated computing device 106 may implement a Boolean circuit 1804(C). In step 1904 of method 1900, circuit composer module 1802 operates to model Boolean circuit 1804(C) as an directed acyclic graph 1806 (G=(V,E)). In graph 1106(G), each node v∈V of in-degree 0 is an input node labelled by either 0 or 1, and there are k such nodes. Each remaining node in graph 1806(G), is either an AND gate, or an OR gate, or a NOT gate, labeled with a bit representing the value of the gate's output wire. Each internal wire of the circuit 1804(C) corresponds to a directed edge in graph 1806(G), where the direction of such edge indicates the direction of signal flow. Node vₒᵤₜ which has an out-degree of 0 represents the output gate of the Boolean circuit 1804. For all i∈[k], graphs Gᵢ represent the Boolean circuit 1804 Cᵢ.

At sub-step 1906, method 1900 identifies vertices 1808 and edges within the acyclic graph 1806. In further detail, the graph 1806 of G′=(V′,E′) as follows:

$${V}^{′} = ( {⋃}_{i = 1}^{k} {V}_{i} ) ⋃ V , and {E}^{′} = ( {⋃}_{i = 1}^{k} {E}_{i} ) ⋃ E .$$

Step 1908 includes defining a computation circuit 1812 by merging vertices u,v∈V in graph G=(V,E) as the following: First, for each w∈V†{u,v}, replace edge (w,v) with new edge (w,u), and (v,w) with (u,w) if there exists such edges. Step 1908 further includes removing node v, and edges (u,v),(v,u) if there exists such edges. Formally, the new graph G′=(V′,E′) resulting from merging node u,v∈V is defined as the following:

V′=V{v},

E″=E{(u,v),(v,u)},

E′=(E{(w,v),(v,w):w∈V})∪{(u,w):(v,w)∈E″}∪{(w,u):(w,v)∈E″}.

Let uᵢ∈Vᵢ be the output gate of Cᵢ, and vᵢ∈V be the i-th input gate of C and for all i∈[k]. Step 1908 of method 1900 further includes merging every pair of vertices uᵢ,vᵢ in graph G′ for i∈[k] and outputs computation circuit 1812 (C′) as the resulting circuit.

The composed circuit 1812 (C′) is then decomposed into individual atomic circuit elements to achieve unlinkability. Using the above-discussed step 1902, Boolean circuit 1804 C is modeled as a directed acyclic graph 1806 G=(V,E), where each vertex of in-degree 0 are labeled as either 0 or 1, representing each input gate to circuit C. Each of the remaining vertices either corresponds to an A N D gate, an OR gate, or a NOT gate. Edges of G represent the wires of circuit C. Before introducing the circuit decomposition algorithm, we explain the term “cutting node” with respect to graph G. For each v∈V, v is a “cutting node” if and only if by cutting the gate at vertex v breaks the Boolean circuit 1804 (C) into two independent Boolean circuits. At a high level, by parsing each cutting node of acyclic graph 1806 (G), a decompose algorithm Decompose(C)→(T,{Cᵥ}_{v∈V}) parses computation circuit 1812 (C′) into smallest chunks of circuits {Cᵥ}_{v∈V}T such that their combination forms a tree structure 1814 T=(V_{T},V_{E}).

At step 1910, circuit composer module 1802 decomposes a Boolean circuit (c) (or C′ including a plurality of sub-circuits) to yield tree structure as follows. Let directed acyclic graph G=(V,E)(e.g. acyclic graph 1806) represent the Boolean circuit C:{0,1}^{k}→{0,1} (e.g., Boolean circuit 1804(C). Consider the split of a vertex u∈V as the following: Sub-step 1812 includes adding a new vertex u′ and a new edge (u,u′). Next for each vertex v such that (u,v)∈E, sub-step 1214 includes replace the edge with (u′,v). Intuitively, the node u is “split” into the edge (u,u′). Formally, the new graph G′=(V′,E′) resulting from splitting the node u into an edge can be defined as:

V′=V∪{u′},

E′=(E†{(u,v):v∈V})∪{(u′,v):(u,v)∈E}∪{(u,u′)}.

Define term “cutting node” as the following: Given G=(V,E) and u∈V, split node u into an edge (u,u′) and obtain a new graph G′=(V′,E′). Vertex u∈V is a cutting node if and only if the out-degree of u (in graph G) is non-zero and edge (u,u′) is a cut of graph G′.

For all cutting nodes u∈V. the Decompose algorithm splits node u into a cutting edge and let set C be the set of all such edges. It obtains a new graph G′=(V′,E′). By removing the edge set C from graph G′, it represents each weakly-connected component of graph (V′,E′−C) as a Boolean circuit. For the weakly connected component that only contains a single vertex, it represents such component as an empty circuit. Then each of the above circuit in graph G′ is contracted into a single vertex to obtains a tree structure T=(V_{T},E_{T}) where each vertex v∈V_{T} represents a Boolean circuit C vas above, and the edge set E_{T} corresponds to C. Note that T is a tree because E_{T} only contains cutting edges. Tree structure 1814 includes a plurality of non-leaf nodes 1816 and leaf nodes 1818. Leaf nodes 1118 are defined as nodes within tree structure 1814 that do not have “child” nodes branching lower in the hierarchy of tree structure 1814, whereas non-leaf nodes 1816 have child nodes branching lower in the hierarchy of tree structure 1814.

Following the compose step 1902 and/or decompose step 1910, method 1900 operates to provide a proof output and validate the proof output as follows. The following description Consider circuit C′={0,1 [symbol] →{0,1}, output bit b, and a valid homomorphic NIZK proof π (e.g., proof output 1122 discussed below) for circuit satisfiability instance (C′,b), then proof certificate r 1128 could be either generated from Prove(crs,C,b,{bᵢ}_{i∈[l]}) algorithm taking (C,b) as instance and {bᵢ}_{i∈[k]} as witness, or homomorphically evaluated from Eval(crs,C,{(Cᵢ,bᵢ,πᵢ)}_{i∈[k]}) such that C′=Compose(C, C₁, . . . , Cₖ). To achieve unlinkability property, a freshly generated proof must be indistinguishable from any evaluated proof.

Method 1900 lets delegated computing device 106, and particularly circuit composer module 1802, decompose the circuit 1812 C′ into the smallest atomic circuits and generate the fresh homomorphic NIZK proof w (e.g., proof output 1822 discussed below) by simulating algorithm “Eval” level by level, following the topological order of those atomic circuits. As a result, a freshly generated proof and a evaluated proof would be generated by the underlying rate-1 NIZK scheme (discussed above) from a universal language. The unlinkability property immediately holds by the zero-knowledge property of rate-1 NIZK.

Method 1900 may implement rate-1 NIZK scheme, in which it the setup step of method 1900 is the same as step 502 of method 500. Therefore, the above-discussion of step 502 is repeated and applies here as well.

In step 1912, method 1900 uses the tree structure T as follows to generate a homomorphic NIZK proof certificate. At sub-step 1914, method 1200 determines if the i-th node is a leaf node or a non-leaf node, if a leaf node, method 1900 moves to step 1916; if a non-leaf node method moves to step 1918. At step 1916, given the i-th leaf node v∈V_{T}, proof generation engine 112 sets

$${C}_{v}^{′} = {C}_{i} , {b}_{v} = {b}_{i} ,$$

and calculates node proof-certificate using the crs 1820, the pair (Cᵢ, b) as instance, and bᵢ as witness and calculates leaf-node proof certificate 1824.

At step 1918, a non-leaf node v∈V_{T} with an in-degree of [symbol] let (v₁, . . . , vₗ) be the child nodes of Cᵥ where Cᵥ takes (bᵥ₁, . . . , bᵥₗ) as input. Proof generation engine 112 computes non-leaf node bit value as

$${b}_{v} = {C}_{v} ( {b}_{{v}_{1}} , … , {b}_{{v}_{l}} ) , {C}_{v}^{′} = Compose ( C , ( {C}_{{v}_{1}}^{′} , … {C}_{{v}_{l}}^{′} ) .$$

Then, proof generation engine 112 generates non-leaf-node proof certificate 1826 by running proof algorithm using crs,

$$( crs , {C}_{v}^{′} , {b}_{v} )$$

as instance value, and {(bᵥ_{ᵢ}, πᵥ_{ᵢ})}_{i∈l} as witness. As such, non-leaf-nodes are an aggregation of the proof certificates of all child nodes thereof.

Steps 1914-1918 iterates as represented by arrow 1920 for every node within tree structure 1814 such that the top-most node in tree structure 1814 is output in proof output 1822 along with function response 1821, which includes the circuit identifier Cᵣₜ 1828, the bit value Bᵣₜ 1830, and proof certificate πᵣₜ 1832 of the root node of tree structure 1814.

Method 1900 further implements, at step 1914 using corresponding verifier engine 126, a verification algorithm that operates to receive crs 1820, and proof output 1822. The verification algorithm takes three inputs: a common reference string (crs) 1818, a tuple consisting of a circuit identifier Cᵣₜ 1828, the bit value Bᵣₜ 1830, and the proof certificate πᵣₜ 1832 as witness. The output of the verification algorithm is either 0 or 1, where 0 indicates that the proof is invalid, and 1 indicates that the proof is valid.

In embodiments, steps 502, 1912, and 1914 operate using the rate-1 NIZK scheme discussed above in FIGS. 8-10. By using rate-1 NIZK scheme, the crs 1820 size is at most poly(λ) since the running time of the above language [symbol] is no more than 2^{λ}. Next we consider the running time of Prove (step 1912), observe that language [symbol] contains a NIZK. Verify step. Again by efficiency of rate-1 NIZK, the NIZK verifier (step 1914) running time is bounded by poly(λ, |x|, |ω|) for some poly(⋅, ⋅, ⋅). Thus the size of language [symbol] is at most poly(λ, |C|). By the rate-1 property of NIZK, there is a poly(λ)-bit overhead of the zero knowledge proof. Otherwise, the proof size is exactly equivalent to the witness size. We observe that the maximum number of NIZK proofs applied is fewer than the number of nodes in the Decompose(C) tree. Thus, the overall overhead size is bounded by poly(λ, |C|). Since the overall witness length k≤|C|, it is established that |π|≤poly(λ, |C|).

Changes may be made in the above methods and systems without departing from the scope hereof. It should thus be noted that the matter contained in the above description or shown in the accompanying drawings should be interpreted as illustrative and not in a limiting sense. The following claims are intended to coverall generic and specific features described herein, as well as all statements of the scope of the present method and system, which, as a matter of language, might be said to fall therebetween.

What is claimed is:

1. A method for delegated computing, comprising:
storing private-data string xₚᵣ and public-data string x_{pbon} a delegated computing device performing a computation;
generating a computational proof that defines proof-certificate π using, as input to a computational proving algorithm:
a common reference string,
public input as an instance element in the computational proving algorithm and based on at least one of: the public-data string X_{pb} or a public-hash digest h_{pb} of the public-data string x_{pb}, and
private input as a witness element in the computational proving algorithm and based on at least one of: the private-data string xₚᵣ or a private-hash digest hₚᵣ of the private-data string xₚᵣ, and
output, to a client device, a proof output including a proof-bit element band the proof-certificate π.

2. The method of claim 1, further comprising determining the common reference string using a setup algorithm using inputs of:
a security parameter 1^{λ},
public-data length n_{pb} of the public-data string x_{pb},
private-data length nₚᵣ of the private-data string xₚᵣ, and
a max configuration size S and a run time T associated with a delegated computing device performing a computation associated with the computational proof.

3. The method of claim 1, further comprising:
determining the private-hash digest hₚᵣ using, as input to a hash algorithm:
the private-data string xₚᵣ, and
a hash key; and
determining an encrypted private-hash-digest ehₚᵣ using, as input to an encryption algorithm;
a random value r,
the private-hash digest hₚᵣ, and
a public-key encryption (PKE) scheme public key.

4. The method of claim 3, further comprising:
generating an encryption computational proof defining encryption proof certificate π_{enc} using as input to an encryption proving algorithm:
an encryption sub-common reference string zk.crs_{enc} of the common reference string,
an instance value based on the encrypted private-hash-digest ehₚᵣ, and
witness value based on the private-data string xₚᵣ, the private-hash digest hₚᵣ, and the random value r.

5. The method of claim 4, further comprising:
determining a public-hash digest h_{pb} based on the public-data string x_{pb} and the hash key;
determining a configuration-state digest h_{Σ} based on a configuration state of the delegated computing device when performing the computation, and the hash key;
generating a delegation computational proof that defines the proof-bit element b, and delegation proof certificate del.π using as input to a delegation proving algorithm:
a delegation sub-common reference string z_{del} of the common reference string, and
a configuration state element of the delegated computing device when performing the computation;
wherein the computational proof defines the proof-certificate π using as input to the computational proving algorithm:
a computation-proof sub-common reference string zk.crs_{edel},
instance element based on:
the public-hash digest h_{pb},
the encrypted private-hash-digest ehₚᵣ,
the configuration-state digest h_{Σ}, and
the proof-bit element b, and
witness element based on:
the private-hash digest hₚᵣ,
the random value r,
and the delegation proof certificate del.π;
wherein the proof output further includes the encrypted private-hash-digest ehₚᵣ, and the encryption proof certificate π_{enc}.

6. The method of claim 5, at least one of the encryption computational proof, the delegation computational proof, and the computational proof being based on a non-interactive zero knowledge proof scheme.

7. The method of claim 4, the proof output further comprising the encryption proof certificate π_{enc} and an auxiliary value based on the private-data string xₚᵣ and the random value r.

8. The method of claim 7, method further comprising:
receiving another delegated-computation request, including the auxiliary value and another computation to be completed using the private-data string xₚᵣ;
generating another computational proof that defines another proof-certificate πₐᵤₓ, using, as input to a computational proving algorithm:
the common reference string,
public input as an instance element and based on at least one of: the public-data string x_{pb} or a public-hash digest h_{pb} of the public-data string x_{pb},
witness element based on the auxiliary value; and
output another proof output including the proof-bit b, the encryption proof certificate π_{enc}, and the other proof-certificate πₐᵤₓ.

9. The method of claim 8, further comprising: identifying previously identified: encrypted private-hash-digest ehₚᵣ, the random value r, and a delegation proof certificate del.π generated using the private-data string xₚᵣ, and associated with the auxiliary value;
wherein:
the common reference string used to generate the other computational proof is a computation-proof sub-common reference string z_{edel},
the instance element used to generate the other computational proof is based on:
the public-hash digest h_{pb},
the encrypted private-hash-digest ehₚᵣ,
a configuration-state digest h_{Σ}, and
the proof-bit b, and
the witness element used to generate the other computational proof is based on:
the private-hash digest hₚᵣ,
the random value r,
and the delegation proof certificate del.π.

10. The method of claim 1, further comprising generating the private input by encoding the private-data string xₚᵣ to yield secret information and an encoding value (ρ).

11. The method of claim 10, wherein the public input is based on the public-data string x_{pb} and the encoding value (ρ).

12. A system for delegated computing, comprising:
a delegated computing device having:
a data storage repository storing private-data string xₚᵣ and public-data string x_{pb}; and
a proving module comprising a proving processor and computer-readable proving instructions that when executed by the proving processor cause the proving module to:
receive delegated-computation request, from the compute machine, including a computation to be completed using the private-data string xₚᵣ,
generate a computational proof, defining proof-bit band proof-certificate ?C, using, as input to a computational proving algorithm:
a common reference string,
instance value based on public input based on at least one of: the public-data string X_{pb} or a public digest h_{pb} of the public-data string x_{pb}, and
witness value based on private input based on at least one of: the private-data string xₚᵣ or a private digest hₚᵣ of the private-data string xₚᵣ, and
output, to a client device, a proof output including the proof-bit band the proof-certificate π; and
the client device comprising a verifying module having a verifying processor and verifying computer-readable verifying instructions that when executed by the verifying processor cause the verifying device to:
receive the proof output, and
generate a verification result based on the common reference string, a public-hash digest h_{pb} of the public-data string x_{pb}, the proof-bit b, and the proof-certificate π.

13. The system of claim 12, the proving device or the verifying device further being caused to calculate the common reference string using a setup algorithm using inputs of:
a security parameter 1^{λ},
an public-data length n_{pb} of the public data x_{pb},
a private-data length nₚᵣ of the private data xₚᵣ, and
a max configuration size S for the delegated computing device, and a run time T.

14. The system of claim 12, the proving device and the verifying device implementing a non-interactive zero-knowledge scheme.

15. The system of claim 12, the computational proof further using as input a configuration state of the delegated computing device when performing the computation.

16. The system of claim 12, the proving instructions further causing, to generate the private input, the proving device to:
determine the private-hash digest hₚᵣ using, as input to a hash algorithm:
the private data xₚᵣ, and
a hash key known to both the proving device and the verifying device; and
determine an encrypted private-hash-digest ehₚr using, as input to an encryption algorithm;
a random value r,
the private-hash digest hₚᵣ, and
a public-key encryption (PKE) scheme public key.

17. The system of claim 16, the proving instructions further causing the proving device to:
generate an encryption computational proof defining encryption proof certificate π_{enc} using as input to an encryption proving algorithm:
an encryption sub-common reference string zk.crs_{enc} of the common reference string,
the encrypted private-hash-digest ehₚᵣ as an instance value, and
a witness value based on the private data xₚᵣ, the private-hash digest hₚᵣ, and the random value r.

18. The system of claim 17, the proving instructions further causing the proving device to:
determine a public-hash digest h_{pb} based on the public data x_{pb} and the hash key;
determine a configuration-state digest hi based on a configuration state of the delegated computing device when performing the computation, and the hash key;
generate a delegation computational proof defining the bit-value b, and delegation proof certificate del.π using as input to a delegation proving algorithm:
a delegation sub-common reference string z_{del} of the common reference string, and
a configuration state element of the delegated computing device when performing the computation;
wherein the computational proof defines the proof-certificate π using as input to the computational proving algorithm:
a computation-proof sub-common reference string z_{edel},
instance element based on:
the public-hash digest h_{pb},
the encrypted private-hash-digest ehₚᵣ,
the configuration-state digest h_{Σ}, and
the bit-value b, and
witness element based on:
the private-hash digest hₚᵣ,
the random value r,
and the delegation proof certificate del.π;
wherein the proof output further includes the encrypted private-hash-digest ehₚᵣ, and the encryption proof certificate π_{enc}.

19. The system of claim 18, the generate the verification result comprising:
generate an encryption verification using:
the encryption sub-common reference string zk.crs_{enc},
the encrypted private-hash-digest ehₚᵣ, and
encryption proof certificate π_{enc}; and
generate a computation-proof verification using:
computation-proof sub-common reference string z_{edel},
the public-hash digest h_{pb}, and
the proof-certificate π.

20. The system of claim 17, the proof output further comprising the encryption proof certificate π_{enc} and an auxiliary value based on private-data string xₚᵣ and the random value r.

21. The system of claim 20, the proving instructions further causing the proving processor to:
receive another delegated-computation request, including another computation to be completed using the private-data string xₚᵣ and the auxiliary value;
generate another computational proof, defining another proof-certificate πₐᵤₓ, using, as input to a computational proving algorithm:
the common reference string,
instance element based on public input based on at least one of: the public-data string x_{pb} or a public digest h_{pb} of the public-data string x_{pb},
witness element based on the auxiliary value; and
output another proof output including the proof-bit b, the encryption proof certificate π_{enc}, and the another proof-certificate πₐᵤₓ.

22. The system of claim 20,
the proving instructions further causing the proving processor to, using the auxiliary value, identify previously identified: encrypted private-hash-digest ehₚᵣ, the random value r, and a delegation proof certificate del.π generated using the private data xₚᵣ,
wherein:
the common reference string used to generate the another computational proof is a computation-proof sub-common reference string z_{edel},
the instant element used to generate the another computational proof is based on:
the public-hash digest h_{pb},
the encrypted private-hash-digest ehₚᵣ,
a configuration-state digest h_{Σ}, and
the proof-bit b, and
a witness element based on:
the private-hash digest hₚᵣ,
the random value r,
and the delegation proof certificate del.π.

23. The system of claim 12, further including one or both of: the private input being generated by encoding the private-data string xₚᵣ to yield secret information and an encoding value (ρ); and the public input is based on the public-data string x_{pb} and the encoding value (ρ).
